(19) United States
(12) Patent Application Publication
(10) Pub. No.: US 2023/0097126 A1
(43) Pub. Date: Mar. 30, 2023

(54) LITHIUM ION SECONDARY BATTERY

(71) Applicant: KABUSHIKI KAISHA TOYOTA JIDOSHOKKI, Kariya-shi, Aichi (JP)

(72) Inventors: Tomoyuki KAWAI, Kariya-shi, Aichi (JP); Kensuke YOTSUMOTO, Kariya-shi, Aichi (JP); Yuki ICHIKAWA, Kariya-shi, Aichi (JP); Satomi YOKOCHI, Kariya-shi, Aichi (JP); Hiroshi IWATA, Kariya-shi, Aichi (JP); Yuya SATO, Kariya-shi, Aichi (JP); Eiji MIZUTANI, Kariya-shi, Aichi (JP); Yushi KONDO, Kariya-shi, Aichi (JP); Takeshi MAKI, Kariya-shi, Aichi (JP); Yoshiyuki OGASAWARA, Kariya-shi, Aichi (JP); Takeshi KIMIJIMA, Kariya-shi, Aichi (JP); Yusuke WATANABE, Kariya-shi, Aichi (JP); Tatsuya EGUCHI, Kariya-shi, Aichi (JP); Shintaro YAMAOKA, Kariya-shi, Aichi (JP)

(73) Assignee: KABUSHIKI KAISHA TOYOTA JIDOSHOKKI, Kariya-shi, Aichi (JP)

(21) Appl. No.: 17/800,409

(22) PCT Filed: Feb. 4, 2021
(86) PCT No.: PCT/JP2021/004135

§ 371 Date: Aug. 17, 2022

(30) Foreign Application Priority Data
Feb. 20, 2020 (JP) 2020-026926
Jul. 28, 2020 (JP) 2020-127791

(51) Int. Cl. H01M 10/0569; H01M 10/0525; H01M 4/505; H01M 4/587; H01M 10/0568; H01M 10/0567

(52) U.S. Cl. CPC H01M 10/0569; H01M 10/0525; H01M 4/505; H01M 4/587; H01M 10/0568; H01M 10/0567; H01M 2300/0037; H01M 2300/0034; H01M 2004/021

(57) ABSTRACT

Provided are an electrolytic solution suitable for a lithium ion secondary battery that includes a positive electrode which has a positive electrode active material having an olivine structure, and includes a negative electrode having graphite as a negative electrode active material, and a superior lithium ion secondary battery having the electrolytic solution. The lithium ion secondary battery includes: a positive electrode that includes a positive electrode active material having an olivine structure; a negative electrode having graphite as a negative electrode active material; and an electrolytic solution. The electrolytic solution contains LiPF₆, a cyclic alkylene carbonate selected from ethylene carbonate and propylene carbonate, methyl propionate, and an additive that starts reductive degradation at a potential higher than a potential at which the above components of the electrolytic solution start reductive degradation.

### TECHNICAL FIELD

The present invention relates to a lithium ion secondary battery that includes a positive electrode which has a positive electrode active material having an olivine structure, a negative electrode which has graphite as a negative electrode active material, and an electrolytic solution.

### BACKGROUND ART

A lithium ion secondary battery having an excellent capacity has been used as power supplies for mobile terminals, personal computers, electric vehicles, and the like. In order to further enhance the capacity of the lithium ion secondary battery, a high capacity positive electrode active material and a high capacity negative electrode active material are to be adopted.

For example, a positive electrode active material, such as LiCoO₂, LiNiO₂, and LiNi_{1/3}Co_{1/3}Mn_{1/3}O₂, having a layered rock salt structure is known as a high capacity positive electrode active material. An Si-containing negative electrode active material has a high lithium occluding ability, and is thus known as a high-capacity negative electrode active material.

However, the lithium ion secondary battery in which a positive electrode active material having a layered rock salt structure is adopted and the lithium ion secondary battery in which an Si-containing negative electrode active material is adopted, have a drawback that an amount of generated heat is great when an abnormality such as short-circuiting occurs.

In order to overcome such a drawback, a method, in which an olivine-structure positive electrode active material having excellent thermal stability but having a lower capacity as compared with a positive electrode active material having a layered rock salt structure is adopted, and graphite having excellent thermal stability but having a lower capacity as compared with an Si-containing negative electrode active material is adopted as a negative electrode active material, has been known.

The lithium ion secondary battery which includes a positive electrode active material having an olivine structure and includes graphite as a negative electrode active material, is described in documents.

Patent Literature 1 indicates that a lithium ion secondary battery that includes a positive electrode active material having an olivine structure provides excellent safety (see paragraph 0014), and specifically describes a lithium ion secondary battery that includes LiFePO₄ having an olivine structure as a positive electrode active material and includes graphite as a negative electrode active material (see experimental examples 1 to 6).

The electrolytic solution used in Patent Literature 1 is obtained by dissolving LiPF₆ in a mixed solvent in which ethylene carbonate and ethyl methyl carbonate are mixed at a volume ratio of 3:7 such that the LiPF₆ concentration is 1 mol/L.

Patent Literature 2 indicates that a positive electrode active material having an olivine structure has high thermal stability (see paragraph 0011), and specifically describes a lithium ion secondary battery that includes LiFePO₄ having an olivine structure as a positive electrode active material and includes graphite as a negative electrode active material (see (Examples 1 to 3).

The electrolytic solution used in Patent Literature 2 is obtained by dissolving LiPF₆ in a mixed solvent in which ethylene carbonate, dimethyl carbonate, and ethyl methyl carbonate are mixed at a volume ratio of 3:2:5 such that the LiPF₆ concentration is 1 mol/L.

As specifically described in Patent Literature 1 and Patent Literature 2, a nonaqueous electrolytic solution in which LiPF₆ is dissolved in a mixed solvent in which an cyclic alkylene carbonate such as ethylene carbonate and a linear carbonate such as dimethyl carbonate and ethyl methyl carbonate are mixed such that the LiPF₆ concentration is about 1 mol/L, is generally used as the electrolytic solution of the lithium ion secondary battery. A linear carbonate is used as a main solvent of the electrolytic solution.

### CITATION LIST

### Patent Literature

Patent Literature 1: JP2010-123300(A)

Patent Literature 2: JP2013-140734(A)

### SUMMARY OF INVENTION

### Technical Problem

As described above, an electrolytic solution used in a lithium ion secondary battery that includes a positive electrode active material having an olivine structure and includes graphite as a negative electrode active material is a nonaqueous electrolytic solution in which LiPF₆ is dissolved in a mixed solvent that contains a linear carbonate as a main solvent and a cyclic alkylene carbonate as a sub-solvent such that the LiPF₆ concentration is about 1 mol/L. Such an electrolytic solution is typically adopted for the lithium ion secondary battery.

However, a lithium ion secondary battery having further enhanced performance is industrially required.

The present invention has been made in view of such circumstances, and an object of the present invention is to provide an electrolytic solution suitable for a lithium ion secondary battery that includes a positive electrode active material having an olivine structure and includes graphite as a negative electrode active material, and to provide a superior lithium ion secondary battery including the electrolytic solution.

### Solution to Problem

The inventor of the present invention has found, as a result of various experiments including basic examinations, that methyl propionate is preferable as a main solvent of the electrolytic solution, and an electrolytic solution containing a specific additive is suitable for a lithium ion secondary battery that includes a positive electrode active material having an olivine structure and includes graphite as a negative electrode active material. The inventor of the present invention has completed the present invention based on the findings.

A lithium ion secondary battery of the present invention includes: a positive electrode that includes a positive electrode active material having an olivine structure; a negative electrode having graphite as a negative electrode active material; and an electrolytic solution. The electrolytic solution contains LiPF₆, a cyclic alkylene carbonate selected from ethylene carbonate and propylene carbonate, methyl propionate, and an additive that starts reductive degradation at a potential higher than a potential at which the above components of the electrolytic solution start reductive degradation.

### Advantageous Effects of Invention

The lithium ion secondary battery of the present invention exhibits excellent battery characteristics and has excellent thermal stability. Furthermore, in response to a request from the industry for enhancing a capacity of the battery, also in a case where the lithium ion secondary battery of the present invention is a high capacity battery, reduction of charging/discharging rate characteristics is inhibited.

### BRIEF DESCRIPTION OF DRAWINGS

FIG. 1 shows a graph representing a relationship between LiPF₆ concentrations and viscosities in each of electrolytic solutions in basic examination 1;

FIG. 2 shows a graph representing a relationship between LiPF₆ concentrations and viscosities in each of electrolytic solutions in basic examination 2;

FIG. 3 shows a graph representing a relationship between LiPF₆ concentrations and ionic conductivities in each of electrolytic solutions in basic examination 2;

FIG. 4 shows a graph for a negative electrode half-cell of each of Example 1, Example 2, and Comparative example 1 in Evaluation example 2;

FIG. 5 shows a graph for a negative electrode half-cell of each of Comparative example 1 to Comparative example 3 in Evaluation example 2;

FIG. 6 shows C1s spectra obtained by XPS analysis of a negative electrode of each of Example 22 and Example 23 in Evaluation example 11;

FIG. 7 shows F1s spectra obtained by XPS analysis of the negative electrode of each of Example 22 and Example 23 in Evaluation example 11;

FIG. 8 shows a graph representing a result of a high temperature charging/discharging cycle test in Evaluation example 15; and

FIG. 9 shows a graph representing a result of a storage test in Evaluation example 16.

### DESCRIPTION OF EMBODIMENTS

An embodiment for carrying out the present invention will be described below. Unless otherwise specified, a numerical value range “x to y” described herein includes, in the range thereof, a lower limit x and an upper limit y. A new numerical value range may be formed by optionally combining the upper limit values and the lower limit values, and numerical values described in the examples. Numerical values optionally selected from any of the numerical value ranges may be used as the upper and lower limit values in a new numerical value range.

A lithium ion secondary battery of the present invention includes: a positive electrode that includes a positive electrode active material having an olivine structure; a negative electrode having graphite as a negative electrode active material; and an electrolytic solution (hereinafter, may also be referred to as electrolytic solution of the present invention).

The electrolytic solution contains LiPF₆, a cyclic alkylene carbonate selected from ethylene carbonate and propylene carbonate, methyl propionate, and an additive (hereinafter, may also be referred to as additive of the present invention) that starts reductive degradation at a potential higher than a potential at which the above components of the electrolytic solution start reductive degradation.

In the description herein, the potential represents potential (vsLi/Li⁺) based on lithium as a reference.

Firstly, the electrolytic solution of the present invention will be described.

In the electrolytic solution of the present invention, the concentration of lithium ions is preferably in a range of 0.8 to 1.8 mol/L, more preferably in a range of 0.9 to 1.5 mol/L, even more preferably in a range of 1.0 to 1.4 mol/L, and particularly preferably in a range of 1.1 to 1.3 mol/L, from the viewpoint of ionic conductivity.

The electrolytic solution of the present invention contains LiPF₆ as a lithium salt. A lithium salt other than LiPF₆ may be contained. Examples of the lithium salt other than LiPF₆ include LiClO₄, LiAsF₆, LiBF₄, FSO₃Li, CF₃SO₃Li, C₂F₅SO₃Li, C₃F₇SO₃Li, C₄F₉SO₃Li, C₅F₁₁SO₃Li, C₆F₁₃SO₃Li, CH₃SO₃Li, C₂H₅SO₃Li, C₃H₇SO₃Li, CF₃CH₂SO₃Li, CF₃C₂H₄SO₃Li, (FSO₂)₂NLi, (CF₃SO₂)₂NLi, (C₂F₅SO₂)₂NLi, FSO₂(CF₃SO₂)NLi, FSO₂(C₂F₅SO₂)NLi, (SO₂CF₂CF₂SO₂)NLi, (SO₂CF₂CF₂CF₂SO₂)NLi, FSO₂(CH₃SO₂)NLi, FSO₂(C₂H₅SO₂)NLi, LiPO₂F₂, LiBF₂(C₂O₄), and LiB(C₂O₄)₂.

A proportion of LiPF₆ in the lithium salt contained in the electrolytic solution of the present invention is preferably in a range of 60 to 100 mol %, more preferably in a range of 70 to 100 mol %, and even more preferably in a range of 80 to 99.5 mol %. Other preferable examples of the proportion of LiPF₆ include a range of 90 to 99 mol %, a range of 95 to 98.5 mol %, and a range of 97 to 98 mol %.

The cyclic alkylene carbonate selected from ethylene carbonate and propylene carbonate is a nonaqueous solvent having a high permittivity, and is considered to contribute to ionic dissociation and dissolution of the lithium salt.

In general, an SEI (solid electrolyte interphase) coating is known to be formed on a surface of a negative electrode by reductive degradation of a cyclic alkylene carbonate during charging of a lithium ion secondary battery. Presence of such an SEI coating is considered to allow lithium ions to be reversibly inserted into and extracted from the negative electrode containing graphite.

The cyclic alkylene carbonate is advantageous as a nonaqueous solvent of an electrolytic solution but has a high viscosity. Therefore, excessively high proportion of the cyclic alkylene carbonate adversely affects ionic conductivity in the electrolytic solution and diffusion of lithium ions in the electrolytic solution in some cases. The melting point of the cyclic alkylene carbonate is relatively high, so that excessively high proportion of the cyclic alkylene carbonate may solidify the electrolytic solution under a low temperature condition.

Meanwhile, methyl propionate is a nonaqueous solvent having a low permittivity, a low viscosity, and a low melting point.

In the electrolytic solution of the present invention, the cyclic alkylene carbonate and methyl propionate coexist, whereby the methyl propionate compensates for the disadvantage of the cyclic alkylene carbonate. That is, methyl propionate is considered to contribute to reduction of a viscosity of the electrolytic solution, an appropriate ionic conductivity, an appropriate diffusion coefficient of lithium ions, and prevention of solidification under a low temperature condition.

The viscosity of the electrolytic solution of the present invention at 25° C. is preferably not greater than 7 mPa·s. Preferable examples of the viscosity range include a range of 0.8 to 6 mPa·s, a range of 1.0 to 4.5 mPa·s, a range of 1.1 to 4.0 mPa·s, a range of 1.2 to 3.0 mPa·s, and a range of 1.3 to 2.5 mPa·s. 1 mPa·s=1 cP is satisfied.

The ionic conductivity of the electrolytic solution of the present invention at 25° C. is preferably not less than 5 mS/cm. Preferable examples of a range of the ionic conductivity include a range of 6 to 30 mS/cm, a range of 7 to 25 mS/cm, a range of 10 to 25 mS/cm, a range of 12 to 25 mS/cm, and a range of 13 to 20 mS/cm.

The diffusion coefficient of lithium ions in the electrolytic solution of the present invention at 30° C. is preferably not less than 1×10⁻¹⁰ m²/s. Preferable examples of a range of the diffusion coefficient of lithium ions include a range of 1.5×10⁻¹⁰ to 10×10⁻¹⁰ m²/s, a range of 2.0×10⁻¹⁰ to 8.0×10⁻¹⁰ m²/s, a range of 2.5×10⁻¹⁰ to 7.0×10⁻¹⁰ m²/s, and a range of 3.0×10⁻¹⁰ to 6.0×10⁻¹⁰ m²/s.

In the electrolytic solution of the present invention, the proportion of the cyclic alkylene carbonate to the total of volumes of the cyclic alkylene carbonate and methyl propionate is preferably in a range of 5 to 50 volume %, more preferably in a range of 10 to 40 volume %, even more preferably in a range of 12 to 30 volume %, particularly preferably in a range of 14 to 20 volume %, and most preferably in a range of 15 to 17 volume %.

Similarly, in the electrolytic solution of the present invention, the proportion of methyl propionate to the total of volumes of the cyclic alkylene carbonate and the methyl propionate is preferably in a range of 50 to 95 volume %, more preferably in a range of 60 to 90 volume o, even more preferably in a range of 70 to 88 volume %, particularly preferably in a range of 75 to 86 volume %, and most preferably in a range of 80 to 85 volume %.

The proportion of the cyclic alkylene carbonate to the entire nonaqueous solvent in the electrolytic solution of the present invention is preferably in a range of 5 to 40 volume %, more preferably in a range of 10 to 35 volume %, even more preferably in a range of 12 to 30 volume %, particularly preferably in a range of 14 to 20 volume %, and most preferably in a range of 15 to 17 volume %.

As the cyclic alkylene carbonate, only ethylene carbonate is selected, only propylene carbonate is selected, or both ethylene carbonate and propylene carbonate are selected.

Propylene carbonate contained in a typical nonaqueous solvent is considered to inhibit lithium ions from being inserted into and extracted from graphite in a lithium ion secondary battery in which graphite is used for a negative electrode. This is considered to be caused by co-insertion of propylene carbonate coordinated with lithium ions into between layers of graphite.

If lithium ions are inhibited from being inserted into and extracted from graphite, a capacity of the lithium ion secondary battery is not sufficiently ensured, and battery characteristics of the lithium ion secondary battery are likely to deteriorate. Therefore, an electrolytic solution containing propylene carbonate in a nonaqueous solvent is not considered to be an electrolytic solution suitable for the lithium ion secondary battery including graphite as a negative electrode active material.

However, as indicated in Examples described below, also in a case where the electrolytic solution of the present invention has propylene carbonate contained in the nonaqueous solvent, reduction of a capacity of the lithium ion secondary battery of the present invention is not found. Rather, excellent durability considered to be derived from propylene carbonate is imparted to the lithium ion secondary battery of the present invention. Therefore, the electrolytic solution of the present invention preferably contains propylene carbonate as the cyclic alkylene carbonate.

Durability of the lithium ion secondary battery is particularly significantly enhanced in a case where both ethylene carbonate and propylene carbonate are used as the cyclic alkylene carbonate at a specific proportion in combination. As the specific proportion, a volume ratio between the ethylene carbonate and the propylene carbonate is, for example, in a range of 20:80 to 80:20, a range of 30:70 to 70:30, a range of 25:75 to 50:50, or a range of 40:60 to 40:60. In the electrolytic solution of the present invention, both ethylene carbonate and propylene carbonate are preferably used in combination as the cyclic alkylene carbonate, and the volume ratio between the ethylene carbonate and the propylene carbonate is considered to be particularly preferably in any of the above-described ranges.

The reason why reduction of a capacity is not found although the electrolytic solution of the present invention has propylene carbonate contained in the nonaqueous solvent, is unclear. However, a composition of the electrolytic solution of the present invention is assumed to be related to the reason. Specifically, the above-described effect is assumed to be exhibited since the electrolytic solution of the present invention contains a fluorine-containing cyclic carbonate and/or an unsaturated cyclic carbonate in addition to oxalate borate as an additive. Therefore, in a case where the lithium ion secondary battery of the present invention has graphite contained in the negative electrode, the electrolytic solution of the present invention preferably has propylene carbonate contained in the nonaqueous solvent, and, furthermore, preferably contains a fluorine-containing cyclic carbonate and/or an unsaturated cyclic carbonate.

A proportion of methyl propionate to the entire nonaqueous solvent in the electrolytic solution of the present invention is preferably in a range of 30 to 95 volume %, more preferably in a range of 40 to 90 volume %, even more preferably in a range of 50 to 89 volume %, particularly preferably in a range of 60 to 88 volume %, and most preferably in a range of 70 to 87 volume %.

As ester having a chemical structure similar to that of methyl propionate, methyl acetate, ethyl acetate, ethyl propionate, methyl butyrate, and ethyl butyrate are present. A specific experimental result described below indicates that physical properties of the electrolytic solution and battery characteristics are more excellent in methyl ester than in ethyl ester. Therefore, ethyl ester is not considered to be preferable.

Next, methyl propionate, methyl acetate, and methyl butyrate as methyl ester, will be described. The melting points and the boiling points thereof are as follows.

As for methyl propionate, the melting point is −88° C. and the boiling point is 80° C.

As for methyl acetate, the melting point is −98° C. and the boiling point is 57° C.

As for methyl butyrate, the melting point is −95° C. and the boiling point is 102° C.

The lithium ion secondary battery is assumed to operate in an environment of about 60° C. Therefore, the nonaqueous solvent contained in the electrolytic solution preferably has a boiling point of not less than 60° C. Also from the viewpoint of production environment, the boiling point of the nonaqueous solvent to be used is preferably high. The greater the number of carbon atoms in ester is, the higher the lipophilicity of the ester is, and this is disadvantageous to dissociation or dissolution of lithium salt. Thus, the number of carbon atoms in ester is preferably small.

In comprehensive consideration of the above-described matters, methyl propionate is considered to be optimal as ester.

The additive of the present invention starts reductive degradation at a potential higher than a potential at which other components of the electrolytic solution, specifically, LiPF₆, the cyclic alkylene carbonate, and methyl propionate, start reductive degradation.

Therefore, when the lithium ion secondary battery of the present invention is charged, the SEI coating derived from reductive degradation of the additive of the present invention is considered to be preferentially formed on a surface of the negative electrode. Presence of the additive of the present invention is considered to inhibit a component of the electrolytic solution other than the additive of the present invention from being excessively reduced and degraded.

Considering preferable operation of the lithium ion secondary battery of the present invention, lithium ions are considered to smoothly pass through the SEI coating derived from reductive degradation of the additive of the present invention under charging and discharging condition of the lithium ion secondary battery that includes the positive electrode active material having an olivine structure and includes graphite as the negative electrode active material.

Examples of the additive of the present invention include cyclic sulfate ester, oxalate borate, and dihalogenated phosphate. As the additive of the present invention, one kind of the additives is used or a plurality of kinds of the additives are used in combination.

The cyclic sulfate ester is a compound represented by the following chemical formula.

R—O—SO₂—O—R (two Rs each represent an alkyl group and bind with each other to form a ring together with —O—S—O—.)

Examples of the cyclic sulfate ester include 5 to 8-membered, 5 to 7-membered, and 5 to 6-membered sulfate esters. The number of carbon atoms in the cyclic sulfate ester is, for example, 2 to 6, 2 to 5, and 2 to 4.

As the oxalate borate, a lithium salt is preferable. Specific examples of the oxalate borate include LiB(C₂O₄)₂ and LiB(C₂O₄)X₂ (X represents a halogen selected from F, Cl, Br, and I).

The oxalate borate is preferably LiB(C₂O₄)₂, that is, lithium bis(oxalato)borate and/or LiB(C₂O₄)F₂, that is, lithium difluoro(oxalato)borate.

As the dihalogenated phosphate, a lithium salt is preferable. Specific examples of the dihalogenated phosphate include LiPO₂X₂ (X represents a halogen selected from F, Cl, Br, and I).

In the electrolytic solution of the present invention, an amount of the additive of the present invention to be added is, for example, in a range of 0.1 to 5 mass %, a range of 0.3 to 4 mass %, a range of 0.5 to 3 mass %, a range of 1 to 2 mass %, a range of 0.6 to 2 mass %, a range of 0.6 to 1.5 mass %, or a range of 0.6 to 1.4 mass %, with respect to the total mass excluding the mass of the additive of the present invention.

The electrolytic solution of the present invention may contain a nonaqueous solvent other than the cyclic alkylene carbonate and methyl propionate, and an additive other than the additive of the present invention.

Particularly, the electrolytic solution of the present invention preferably contains a fluorine-containing cyclic carbonate and/or an unsaturated cyclic carbonate. In a case where the additive of the present invention and the fluorine-containing cyclic carbonate and/or the unsaturated cyclic carbonate coexist, performance of the lithium ion secondary battery of the present invention is enhanced.

Examples of the fluorine-containing cyclic carbonate include fluoroethylene carbonate, 4-(trifluoromethyl)-1,3-dioxolane-2-one, 4,4-difluoro-1,3-dioxolane-2-one, 4-fluoro-4-methyl-1,3-dioxolane-2-one, 4-(fluoromethyl)-1,3-dioxolane-2-one, 4,5-difluoro-1,3-dioxolane-2-one, 4-fluoro-5-methyl-1,3-dioxolane-2-one, and 4,5-difluoro-4,5-dimethyl-1,3-dioxolane-2-one.

Examples of the unsaturated cyclic carbonate include vinylene carbonate, fluorovinylene carbonate, methylvinylene carbonate, fluoromethylvinylene carbonate, ethylvinylene carbonate, propylvinylene carbonate, butylvinylene carbonate, dimethylvinylene carbonate, diethylvinylene carbonate, dipropylvinylene carbonate, trifluoromethylvinylene carbonate, and vinylethylene carbonate.

The electrolytic solution of the present invention particularly preferably contains fluoroethylene carbonate and/or vinylene carbonate.

In the electrolytic solution of the present invention, an amount of the fluorine-containing cyclic carbonate and/or the unsaturated cyclic carbonate to be added is, for example, in a range of 0.1 to 5 mass %, a range of 0.3 to 4 mass %, a range of 0.5 to 3 mass %, and a range of 1 to 2 mass %, with respect to the total mass excluding the masses of the fluorine-containing cyclic carbonate and the unsaturated cyclic carbonate.

The inventor of the present invention has found, through thorough study, that, in a case where the positive electrode of the lithium ion secondary battery of the present invention contains LiMnₓFe_{y}PO₄ described below as the positive electrode active material having an olivine structure, durability of the lithium ion secondary battery is reduced as compared with a case where LiMnₓFe_{y}PO₄ is not contained. This is assumed to be because a transition metal is eluted from the positive electrode according to the charging/discharging to cause deterioration of the positive electrode. One of the causes is assumed to be an additive contained in the electrolytic solution of the present invention, specifically, lithium difluoro(oxalato)borate as one mode of the oxalate borate.

The inventor of the present invention has attempted to inhibit the deterioration of the positive electrode based on the finding. The inventor has found that, in a case where the electrolytic solution of the present invention contains a nitrile as a second additive in addition to the above-described additive, the above-described deterioration of the lithium ion secondary battery is inhibited. Although the reason is unclear, the following reason is inferred.

A coating is formed also on the surface of the positive electrode according to the charging/discharging of the lithium ion secondary battery due to oxidation of the electrolytic solution. Inhibition of the above-described deterioration of the positive electrode is expected by separating the positive electrode and the electrolytic solution by the coating.

The coating is considered to contain nitrogen. Therefore, in a case where the electrolytic solution of the present invention contains a nitrile, the nitrile acts as a material of the coating. That is, in a case where the electrolytic solution of the present invention contains a nitrile, a sufficient amount of nitrogen is considered to be supplied to the surface of the positive electrode, to promote formation of the coating on the surface of the positive electrode.

The electrolytic solution of the present invention containing a nitrile as the second additive is also usable for the lithium ion secondary battery of the present invention having the positive electrode that does not contain LiMnₓFe_{y}PO₄. Also in this case, deterioration of the positive electrode is inhibited.

The nitrile contained in the electrolytic solution of the present invention may be a nitrile having a cyano group. Specific examples of the nitrile include succinonitrile, adiponitrile, 2-ethylsuccinonitrile, acetonitrile methylacetonitrile, (dimethylamino)acetonitrile, trimethylacetonitrile, phenylacetonitrile, dichloroacetonitrile, propiononitrile, butyronitrile, isobutyronitrile, pentanenitrile, hexanedinitrile, oxalonitrile, glutaronitrile, acrylonitrile, cyclopropanecarbonitrile, cyclopentanecarbonitrile, cyclohexanecarbonitrile, ethenetetracarbonitrile, and 1,2,3-propanetricarbonitrile.

Preferable examples of a range of an amount of the nitrile in the electrolytic solution include a range of 0.05 to 10 mass %, a range of 0.08 to 5 mass %, a range of 0.1 to 2.0 mass %, and a range of 0.25 to 1.0 mass % when the total mass of the electrolytic solution excluding the above-described additives and the second additive (nitrile) is 100 mass %.

Specifically, the positive electrode that has the positive electrode active material having an olivine structure includes a current collector, and a positive electrode active material layer that is formed on the surface of the current collector and that contains the positive electrode active material.

The current collector refers to a chemically inert electron conductor for continuously sending a flow of current to the electrode during discharging or charging of the lithium ion secondary battery. Examples of the current collector include at least one selected from silver, copper, gold, aluminum, magnesium, tungsten, cobalt, zinc, nickel, iron, platinum, tin, indium, titanium, ruthenium, tantalum, chromium, and molybdenum, and metal materials such as stainless steel.

The current collector may be coated with a known protective layer. A current collector having a surface treated in a known method may be used as the current collector.

The current collector takes the form of, for example, foil, a sheet, a film, a line shape, a bar shape, or a mesh. Therefore, as the current collector, for example, metal foil such as copper foil, nickel foil, aluminum foil, or stainless steel foil is preferably used. In a case where the current collector is in the form of foil (hereinafter, referred to as current collector foil), the thickness of the current collector foil is preferably in a range of 1 μm to 100 μm.

The positive electrode active material having an olivine structure has a lower electron conductivity as compared with a positive electrode active material, such as LiCoO₂, LiNiO₂, and LiNi_{1/3}Co_{1/3}Mn_{1/3}O₂, having a layered rock salt structure. Therefore, resistance between the current collector foil and the positive electrode active material layer is preferably reduced by using current collector foil having a rough surface, specifically, current collector foil in which the arithmetic average height Sa in surface roughness satisfies 0.1 μm≤Sa.

The arithmetic average height Sa in the surface roughness refers to an arithmetic average height in surface roughness defined in ISO 25178, and refers to an average value of absolute values of differences of heights, at respective points, with respect to the average surface in the surface of the current collector foil.

In order to prepare current collector foil having a rough surface, the current collector foil may be produced in a method in which metal current collector foil is coated with carbon or a method in which metal current collector foil is treated with acid or alkali, or commercially available current collector foil having a rough surface may be obtained.

In order to prepare the positive electrode active material having an olivine structure, a commercially available positive electrode active material having an olivine structure may be obtained, or the positive electrode active material having an olivine structure may be produced with reference to the method described in the following documents or the like. As the positive electrode active material having an olivine structure, a positive electrode active material having an olivine structure and coated with carbon is preferable.

JPH11-25983(A)

JP2002-198050(A)

JP2005-522009(A)

JP2012-79554(A)

The positive electrode active material having an olivine structure is, for example, LiₐM_{b}PO₄ (M represents at least one element selected from Mn, Fe, Co, Ni, Cu, Mg, Zn, V, Ca, Sr, Ba, Ti, Al, Si, B, Te, and Mo. a satisfies 0.9≤a≤1.2 and b satisfies 0.6≤b≤1.1) when represented by a chemical formula.

The range of a is, for example, 0.95≤a≤1.1 or 0.97≤a≤1.05.

M in LiₐM_{b}PO₄ is preferably at least one element selected from Mn, Fe, Co, Ni, Mg, V, and Te, and M is more preferably formed of two or more elements. M is more preferably selected from Mn, Fe, and V. b preferably satisfies 0.95≤b≤1.05.

LiₐM_{b}PO₄ is more preferably represented by LiMnₓFe_{y}PO₄ (x and y satisfy x+y=1, 0<x<1, and 0<y<1) having Mn and Fe as essential elements. The ranges of x and y are, for example, 0.5≤x≤0.9 and 0.1≤y≤0.5, and 0.6≤x≤0.8 and 0.2≤y≤0.4, and are furthermore 0.7≤x≤0.8 and 0.2≤y≤0.3.

As the positive electrode active material having an olivine structure, LiFePO₄ is generally used. However, LiMnₓFe_{y}PO₄ in which Mn and Fe coexist is known to have a reaction potential higher than that of LiFePO₄.

The positive electrode active material layer may contain additives such as a conductive additive, a binding agent, and a dispersant in addition to the positive electrode active material. The positive electrode active material layer may contain a known positive electrode active material other than the positive electrode active material having an olivine structure without departing from the gist of the present invention.

Examples of a proportion of the positive electrode active material having an olivine structure in the positive electrode active material layer include a range of 70 to 99 mass %, a range of 80 to 98 mass %, and a range of 90 to 97 mass %.

The conductive additive is added for enhancing conductivity of the electrode. Therefore, the conductive additive is optionally added in a case where conductivity of the electrode is insufficient, and need not be added in a case where conductivity of the electrode is sufficiently excellent.

The conductive additive may be a chemically inert electron conductor, and examples of the conductive additive include carbon black as carbonaceous fine particles, graphite, vapor grown carbon fiber, and carbon nanotube, and various metal particles. Examples of the carbon black include acetylene black, KETJENBLACK (registered trademark), furnace black, and channel black. One kind of the conductive additives may be added alone or two or more kinds of the conductive additives may be added in combination to the positive electrode active material layer.

A blending amount of the conductive additive is not particularly limited. A proportion of the conductive additive in the positive electrode active material layer is preferably in a range of 1 to 7 mass %, more preferably in a range of 2 to 6 mass %, and even more preferably in a range of 3 to 5 mass %.

The binding agent acts so as to adhere the positive electrode active material and the conductive additive to the surface of the current collector. Examples of the binding agent include fluorine-containing resins such as polyvinylidene fluoride, polytetrafluoroethylene, and fluororubber, thermoplastic resins such as polypropylene and polyethylene, imide-based resins such as polyimide and polyamide-imide, alkoxysilyl group-containing resins, poly(meth)acrylate-based resins, polyacrylic acid, polyvinyl alcohol, polyvinylpyrrolidone, carboxymethylcellulose, and styrene butadiene rubber.

A blending amount of the binding agent is not particularly limited. A proportion of the binding agent in the positive electrode active material layer is preferably in a range of 0.5 to 7 mass %, more preferably in a range of 1 to 5 mass %, and even more preferably in a range of 2 to 4 mass %.

As the additive such as a dispersant other than the conductive additive and the binding agent, a known additive is used.

The negative electrode having graphite as the negative electrode active material specifically includes a current collector, and a negative electrode active material layer that is formed on the surface of the current collector and that contains the negative electrode active material. As the current collector, the current collector described for the positive electrode is properly adopted as appropriate. The negative electrode active material layer may contain a known negative electrode active material other than graphite without departing from the gist of the present invention.

The graphite is not limited as long as the graphite functions as the negative electrode active material of the lithium ion secondary battery, and is, for example, natural graphite or artificial graphite.

A proportion of the graphite in the negative electrode active material layer is, for example, in a range of 70 to 99 mass %, a range of 80 to 98.5 mass %, a range of 90 to 98 mass %, and a range of 95 to 97.5 mass %.

The negative electrode active material layer may contain an additive such as a binding agent and a dispersant in addition to the negative electrode active material. As the binding agent, the binding agent described for the positive electrode is properly adopted as appropriate. As the additive such as a dispersant, a known additive is used.

A blending amount of the binding agent is not particularly limited. A proportion of the binding agent in the negative electrode active material layer is preferably in a range of 0.5 to 7 mass %, more preferably in a range of 1 to 5 mass %, and even more preferably in a range of 2 to 4 mass %.

In order to form the active material layer on the surface of the current collector, the active material is applied to the surface of the current collector by using a conventionally known method such as a roll coating method, a die coating method, a dip coating method, a doctor blade method, a spray coating method, and a curtain coating method. Specifically, the active material, a solvent, and, as necessary, the binding agent and the conductive additive are mixed to produce an active material layer forming composition in a slurry form, and the active material layer forming composition is applied to the surface of the current collector and thereafter dried. Examples of the solvent include N-methyl-2-pyrrolidone, methanol, methyl isobutyl ketone, and water. In order to enhance an electrode density, the dried product may be compressed.

The active material layer may be formed by using the production method disclosed in JP2015-201318(A) or the like.

Specifically, in the method, a mixture containing the active material, the binding agent, and the solvent is granulated, to obtain granular products in a wet state, the aggregate of the granular products is put into a predetermined mold to obtain a flat-plate-shaped molded product, and the flat-plate-shaped molded product is thereafter adhered to the surface of the current collector by using a transfer roll, to form the active material layer.

The lithium ion secondary battery that includes the positive electrode which has the positive electrode active material having an olivine structure, and the negative electrode having graphite as the negative electrode active material, has excellent thermal stability but has low capacity per unit volume of the electrode.

A high-capacity lithium ion secondary battery is industrially required. As a method for responding to the request, a method in which amounts of the positive electrode active material and the negative electrode active material per electrode are increased, specifically, a method in which amounts of the positive electrode active material layer and the negative electrode active material layer to be applied to the current collector foil are increased, is considered. Through the method in which the amounts of the positive electrode active material layer and the negative electrode active material layer to be applied to the current collector foil are increased, a mass (hereinafter, may be referred to as “weight per area of the positive electrode”) of the positive electrode active material layer on one square centimeter area of one surface of the current collector foil of the positive electrode, and a mass (hereinafter, may be referred to as “weight per area of the negative electrode”) of the negative electrode active material layer on one square centimeter area of one surface of the current collector foil of the negative electrode, are increased.

The weight per area of the positive electrode is preferably not less than 20 mg/cm². Preferable examples of the weight per area of the positive electrode include a range of 30 to 200 mg/cm², a range of 35 to 150 mg/cm², a range of 40 to 120 mg/cm², and a range of 50 to 1000 mg/cm².

The weight per area of the negative electrode is preferably not less than 10 mg/cm². Preferable examples of the weight per area of the negative electrode include a range of 15 to 100 mg/cm², a range of 17 to 75 mg/cm², a range of 20 to 60 mg/cm², and a range of 25 to 50 mg/cm².

In general, in a lithium ion secondary battery including a thickly coated electrode in which a weight per area is great and an active material layer has a great thickness, a rate characteristics deterioration phenomenon in which charge/discharge capacity at a high rate becomes insufficient as compared with charge/discharge capacity at a low rate occurs. The rate characteristics deterioration phenomenon is considered to be related to diffusion resistance of lithium ions in the lithium ion secondary battery, and the diffusion resistance of lithium ions is considered to be related to a viscosity of an electrolytic solution and a diffusion coefficient of lithium ions in the electrolytic solution.

The electrolytic solution of the present invention has a low viscosity due to presence of methyl propionate, and is designed in consideration of a diffusion coefficient of lithium ions. Therefore, in the lithium ion secondary battery of the present invention, the rate characteristics deterioration phenomenon is inhibited to some degree.

The lithium ion secondary battery of the present invention may include a bipolar electrode in which the positive electrode active material layer is formed on one surface of the current collector foil, and the negative electrode active material layer is formed on the other surface.

In the case of the bipolar electrode, a multilayer structure formed of a plurality of different kinds of metals may be used for the current collector foil.

Examples of the multilayer structure include a structure in which a base metal is plated with a different kind of metal, a structure in which a different kind of metal is rolled and joined to a base metal, and a structure in which different kinds of metals are joined to each other by a conductive adhesive. Specifically, the multilayer structure is, for example, metal foil in which aluminum foil is plated with nickel.

The lithium ion secondary battery of the present invention includes a separator for isolating the positive electrode and the negative electrode from each other, and allowing lithium ions to pass therethrough while preventing short-circuiting caused by contact between both the electrodes.

As the separator, a known separator is adopted. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. A separator having a multilayer structure is also used. Specifically, in order to achieve high adhesion between the electrode and the separator, for example, an adhesive separator in which an adhesive layer is formed on a separator, and an application-type separator in which high temperature heat-resistance is enhanced by forming, on a separator, a coating film containing an inorganic filler or the like, are used.

A specific method for producing the lithium ion secondary battery will be described. For example, the separator is held between the positive electrode and the negative electrode to produce an electrode assembly. The electrode assembly may be either a laminated-type one obtained by stacking the positive electrode, the separator, and the negative electrode, or a wound type one obtained by winding a laminated body of the positive electrode, the separator, and the negative electrode. The lithium ion secondary battery is preferably formed by respectively connecting, using current collecting leads or the like, the positive electrode current collector to a positive electrode external connection terminal and the negative electrode current collector to a negative electrode external connection terminal, and then adding the electrolytic solution to the electrode assembly.

A specific production method in the case of a bipolar electrode being used as the electrode of the lithium ion secondary battery will be described. For example, the positive electrode active material layer of one bipolar electrode and the negative electrode active material layer of a bipolar electrode adjacent to the one bipolar electrode are stacked so as to oppose each other across the separator to produce an electrode assembly. The peripheral edge of the electrode assembly is coated with resin or the like, whereby a space is formed between the one bipolar electrode and the bipolar electrode adjacent to the one bipolar electrode, and the electrolytic solution is added into the space to produce the lithium ion secondary battery.

The shape of the lithium ion secondary battery of the present invention is not particularly limited, and various shapes such as a cylindrical shape, a square shape, a coin-like shape, and a laminated shape are adopted.

In general, a state of the positive electrode, the separator, and the negative electrode in the lithium ion secondary battery includes a laminated state in which a flat-plate-like positive electrode, a flat-plate-like separator, and a flat-plate-like negative electrode are stacked, and a wound state in which the positive electrode, the separator, and the negative electrode are wound. In the lithium ion secondary battery in the wound state, a bending force is applied to an active material layer of the electrode and bending stress is generated in the active material layer.

An active material layer of a lithium ion secondary battery that includes a thickly-coated electrode having a great weight per area is not considered to have such flexibility as to follow the bending force generated in the wound state.

Therefore, among the lithium ion secondary batteries of the present invention, a lithium ion secondary battery having a thickly coated electrode is preferably of a laminated type in which the flat-plate like positive electrode, the flat-plate like separator, and the flat-plate like negative electrode are stacked. Furthermore, in the lithium ion secondary battery of the present invention, multiple layers are preferably stacked by repeatedly stacking the positive electrode having the positive electrode active material layer formed on both surfaces of the current collector foil, the separator, and the negative electrode having the negative electrode active material layer formed on both surfaces of the current collector foil, in the order of the positive electrode, the separator, the negative electrode, the separator, the positive electrode, the separator, and the negative electrode. The lithium ion secondary battery of the present invention preferably has multiple layers formed by stacking a separator and a bipolar electrode having the positive electrode active material layer formed on one surface of the current collector foil and the negative electrode active material layer formed on the other surface.

The lithium ion secondary battery of the present invention may be mounted on a vehicle. The vehicle may be a vehicle that uses, as all or one portion of the source of power, electrical energy obtained from the lithium ion secondary battery, and examples thereof include electric vehicles and hybrid vehicles. When the lithium ion secondary battery is to be mounted on the vehicle, a plurality of the lithium ion secondary batteries may be connected in series to form an assembled battery. Other than the vehicles, examples of instruments on which the lithium ion secondary battery may be mounted include various home appliances, office instruments, and industrial instruments driven by a battery such as personal computers and portable communication devices. In addition, the lithium ion secondary battery of the present invention may be used as power storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and power storage devices for temporarily storing power required for charging at charge stations for electric vehicles.

Although the present invention has been described above, the present invention is not limited to the embodiments. Without departing from the gist of the present invention, the present invention can be implemented in various modes with modifications and improvements, etc., that can be made by a person skilled in the art.

### EXAMPLES

The present invention is more specifically described below by means of examples, comparative examples, and the like. The present invention is not limited to these examples.

<Basic Examination 1: Comparison in Viscosity Between Ester Solvent and Linear Carbonate Solvent>

LiPF₆ was dissolved in a solvent obtained by mixing at a volume ratio indicated below in Table 1 to produce No. 1 to No. 15 electrolytic solutions. A viscosity of each electrolytic solution at 25° C. was measured by a type B viscometer (Brookfield, DV2T) with use of a cone-type spindle. The rotation speed of the cone-type spindle was as indicated in Table 1.

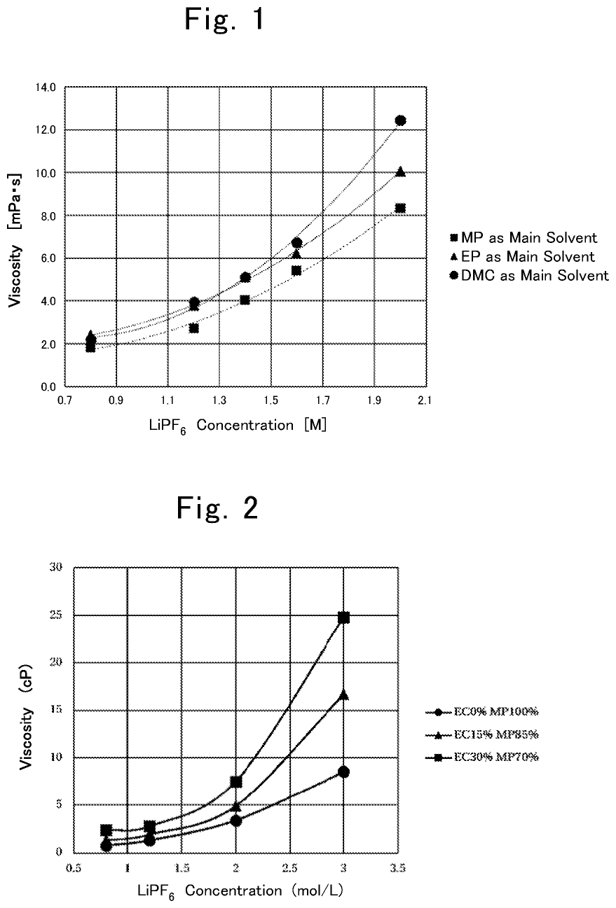

The results are indicated in Table 1 and FIG. 1.

EC represents an abbreviation of ethylene carbonate. MP represents an abbreviation of methyl propionate. EP represents an abbreviation of ethyl propionate. DMC represents an abbreviation of dimethyl carbonate.

TABLE 1

| | LiPF₆ | | | | | | Rotation |
|---|---|---|---|---|---|---|---|
| | concentration | | | | | Viscosity | speed |
| | (mol/L) | EC | MP | EP | DMC | (mPa · s) | (rpm) |
| No. 1 | 0.8 | 30 | 70 | 0 | 0 | 1.8 | 60 |
| No. 2 | 1.2 | 30 | 70 | 0 | 0 | 2.7 | 60 |
| No. 3 | 1.4 | 30 | 70 | 0 | 0 | 4.0 | 50 |
| No. 4 | 1.6 | 30 | 70 | 0 | 0 | 5.4 | 30 |
| No. 5 | 2.0 | 30 | 70 | 0 | 0 | 8.3 | 20 |
| No. 6 | 0.8 | 30 | 0 | 70 | 0 | 2.4 | 60 |
| No. 7 | 1.2 | 30 | 0 | 70 | 0 | 3.8 | 50 |
| No. 8 | 1.4 | 30 | 0 | 70 | 0 | 5.1 | 30 |
| No. 9 | 1.6 | 30 | 0 | 70 | 0 | 6.2 | 20 |
| No. 10 | 2.0 | 30 | 0 | 70 | 0 | 10.1 | 20 |
| No. 11 | 0.8 | 30 | 0 | 0 | 70 | 2.2 | 60 |
| No. 12 | 1.2 | 30 | 0 | 0 | 70 | 3.9 | 50 |
| No. 13 | 1.4 | 30 | 0 | 0 | 70 | 5.1 | 30 |
| No. 14 | 1.6 | 30 | 0 | 0 | 70 | 6.7 | 20 |
| No. 15 | 2.0 | 30 | 0 | 0 | 70 | 12.4 | 12 |

The results in Table 1 and FIG. 1 indicate that the electrolytic solution containing ester as a main solvent tended to have a lower viscosity as compared with the electrolytic solution in which dimethyl carbonate as a linear carbonate was contained as a main solvent. The results of No. 1 to No. 10 indicate that the electrolytic solution containing methyl propionate as a main solvent had a lower viscosity as compared with the electrolytic solution containing ethyl propionate as a main solvent.

From the viewpoint of viscosity, methyl propionate is considered to be preferably selected as a main solvent of the electrolytic solution.

LiPF₆ was dissolved at a concentration of 1.2 mol/L in a solvent obtained by mixing at a volume ratio indicated below in Table 2 to produce No. 16 to No. 23 electrolytic solutions. A viscosity of each electrolytic solution at 25° C. was measured in the same manner as in the above-described viscosity measurement. The rotation speed of the cone-type spindle was as indicated in Table 2. The result is indicated in Table 2.

TABLE 2

| | | | | | | Rotation |
|---|---|---|---|---|---|---|
| | | | | | Viscosity | speed |
| | EC | MP | EP | DMC | (mPa · s) | (rpm) |
| No. 16 | 30 | 0 | 0 | 70 | 3.9 | 50 |
| No. 17 | 30 | 15 | 0 | 55 | 3.9 | 50 |
| No. 18 | 30 | 30 | 0 | 40 | 3.8 | 50 |
| No. 19 | 30 | 50 | 0 | 20 | 3.5 | 50 |
| No. 20 | 30 | 70 | 0 | 0 | 2.7 | 60 |
| No. 21 | 30 | 0 | 15 | 55 | 4.0 | 50 |
| No. 22 | 30 | 0 | 50 | 20 | 4.0 | 50 |
| No. 23 | 30 | 0 | 70 | 0 | 3.8 | 50 |

The result in Table 2 indicates that the viscosity of the electrolytic solution was reduced by substituting methyl propionate for dimethyl carbonate as a linear carbonate. Meanwhile, even in a case where ethyl propionate was substituted for dimethyl carbonate as a linear carbonate, the viscosity of the electrolytic solution was considered to be hardly changed.

The results of No. 17 to No. 20 indicate that, in a case where the volume of methyl propionate was not less than the volume of ethylene carbonate, or in a case where the volume of methyl propionate was not less than 30 volume % with respect to the total volume of the nonaqueous solvent, the viscosity of the electrolytic solution was considered to be significantly reduced.

<Basic Examination 2: Relationship Between LiPF₆ Concentration and Proportions of Ethylene Carbonate and Methyl Propionate, and Viscosity and Ionic Conductivity>

LiPF₆ was dissolved in a solvent obtained by mixing at a volume ratio indicated below in Table 3 to produce No. 1 to No. 12 electrolytic solutions. The viscosity and the ionic conductivity of each electrolytic solution were measured in the following conditions.

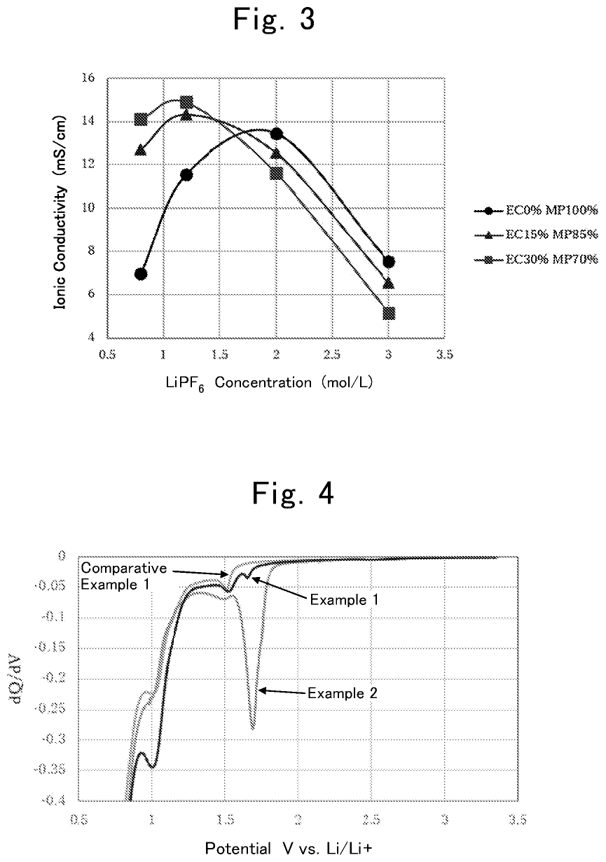

The results are indicated in Table 3, and FIG. 2 and FIG. 3.

<Viscosity> The viscosity of each electrolytic solution at 25° C. was measured by the type B viscometer (Brookfield, DV2T) with use of a cone-type spindle. The rotation speed of the cone-type spindle was as indicated in Table 3.

<Ionic conductivity> The electrolytic solution was sealed in a cell having a platinum electrode, and resistance was measured by an impedance method in an environment of 25° C. The ionic conductivity was calculated from the result of the resistance measurement. As a measurement instrument, Solartron 147055BEC (Solartron Analytical) was used.

TABLE 3

| | | | | | | Ionic |
|---|---|---|---|---|---|---|
| | LiPF₆ | | | | Rotation | conduc- |
| | concentration | | | Viscosity | speed | tivity |
| | (mol/L) | EC | MP | (cP) | (rpm) | (mS/cm) |
| No. 1 | 0.8 | 0 | 100 | 0.79 | 100 | 6.96 |
| No. 2 | 1.2 | 0 | 100 | 1.34 | 100 | 11.53 |
| No. 3 | 2.0 | 0 | 100 | 3.40 | 50 | 13.45 |
| No. 4 | 3.0 | 0 | 100 | 8.54 | 20 | 7.52 |
| No. 5 | 0.8 | 15 | 85 | 1.29 | 100 | 12.72 |
| No. 6 | 1.2 | 15 | 85 | 1.91 | 50 | 14.33 |
| No. 7 | 2.0 | 15 | 85 | 4.89 | 50 | 12.55 |
| No. 8 | 3.0 | 15 | 85 | 16.72 | 10 | 6.55 |
| No. 9 | 0.8 | 30 | 70 | 2.41 | 50 | 14.12 |
| No. 10 | 1.2 | 30 | 70 | 2.80 | 50 | 14.89 |
| No. 11 | 2.0 | 30 | 70 | 7.54 | 30 | 11.61 |
| No. 12 | 3.0 | 30 | 70 | 24.83 | 6 | 5.16 |

Firstly, the viscosity is reviewed.

The table indicates that the viscosity of the electrolytic solution was increased according to increase of the LiPF₆ concentration. The less a proportion of ethylene carbonate was, in other words, the greater a proportion of methyl propionate was, the less the degree of increase of the viscosity according to the increase of the LiPF₆ concentration was. Conversely, in the electrolytic solution in which the proportion of ethylene carbonate was great and the proportion of methyl propionate was small, increase of the LiPF₆ concentration was considered to cause abrupt increase of the viscosity.

In the electrolytic solution adopted for a thickly coated electrode, variation in lithium salt concentration is assumed to occur during charging/discharging. Therefore, the electrolytic solution that allows inhibition of change in viscosity when the lithium salt concentration is changed is considered to be preferable. From such a viewpoint, the electrolytic solution in which a proportion of ethylene carbonate is small and a proportion of methyl propionate is great is considered to be preferable.

Next, the ionic conductivity is reviewed.

The graph in FIG. 3 indicates that change of a composition of the solvent was considered to change a maximal value of the ionic conductivity.

The graph indicates that, in the case of the electrolytic solution containing no ethylene carbonate, the maximal value of the ionic conductivity appeared at the LiPF₆ concentration of about 2 mol/L, and the lithium ions were not sufficiently dissociated in the electrolytic solution having the LiPF₆ concentration of not less than 2 mol/L. In the case of the electrolytic solution containing no ethylene carbonate, change of the ionic conductivity with respect to change of the LiPF₆ concentration was considered to be great.

As described above, in the electrolytic solution adopted for a thickly coated electrode, variation in lithium salt concentration is assumed to occur during charging/discharging. Therefore, the electrolytic solution that allows inhibition of change in ionic conductivity when the lithium salt concentration is changed is considered to be preferable. From such a viewpoint, the electrolytic solution that contains no ethylene carbonate is not considered to be preferable.

In the case of the electrolytic solution containing 15 volume % of ethylene carbonate, the maximal value of the ionic conductivity was considered to appear in a range of the LiPF₆ concentration of 1.1 to 1.6 mol/L. Change of the ionic conductivity with respect to change of the LiPF₆ concentration was considered to be relatively small.

In the case of the electrolytic solution containing 30 volume % of ethylene carbonate, the maximal value of the ionic conductivity was considered to appear in a range of the LiPF₆ concentration of 0.9 to 1.4 mol/L. Change of the ionic conductivity with respect to change of the LiPF₆ concentration was considered to be relatively small.

In the electrolytic solution containing ethylene carbonate at a certain proportion, change of the ionic conductivity with respect to change of the LiPF₆ concentration is relatively small. Therefore, the electrolytic solution containing ethylene carbonate at a certain proportion is considered to be suitable as the electrolytic solution of the lithium ion secondary battery having a thickly coated electrode.

According to the results in Table 3, and FIG. 2 and FIG. 3, unique correlation between the viscosity and the ionic conductivity was not considered to be found.

Comprehensive review of the results about the viscosity and the ionic conductivity indicates that the proportion of ethylene carbonate is considered to be preferably in a range of 5 to 25 volume %.

<Basic examination 3: Relationship Between LiPF₆ Concentration and Proportions of Ethylene Carbonate and Methyl Propionate, and Diffusion Coefficient and Transference Number of Lithium Ions>

LiPF₆ was dissolved in a solvent obtained by mixing at a volume ratio indicated below in Table 4 to produce No. 1 to No. 9 electrolytic solutions. The diffusion coefficient and the transference number of each electrolytic solution were measured by a pulsed field gradient NMR method under a condition of 30° C. Specifically, an NMR tube having the electrolytic solution therein was disposed in a PFG-NMR device (ECA-500, JEOL Ltd.), and analysis in which ⁷Li and ¹⁹F were targets was performed while a magnetic field pulse width was changed, and the diffusion coefficients of Li⁺ and PF₆⁻ in the electrolytic solution were calculated from the result.

The transference number of lithium ions was calculated according to the following equation.

Transference number=(diffusion coefficient of Li⁺)/(diffusion coefficient of Li⁺+diffusion coefficient of PF₆⁻)

The results for the above are indicated in Table 4.

TABLE 4

| | | | | Diffusion | Diffusion | |
|---|---|---|---|---|---|---|
| | LiPF₆ | | | coefficient | coefficient | |
| | concen- | | | of Li⁺ | of PF₆⁻ | Trans- |
| | tration | | | (×10⁻¹⁰ | (×10⁻¹⁰ | ference |
| | (mol/L) | EC | MP | m²/s) | m²/s) | number |
| No. 1 | 1.2 | 0 | 100 | 6.54 | 7.52 | 0.47 |
| No. 2 | 2.0 | 0 | 100 | 3.16 | 3.35 | 0.49 |
| No. 3 | 3.0 | 0 | 100 | 1.06 | 1.09 | 0.49 |
| No. 4 | 1.2 | 15 | 85 | 4.43 | 4.99 | 0.47 |
| No. 5 | 2.0 | 15 | 85 | 2.13 | 2.58 | 0.45 |
| No. 6 | 3.0 | 15 | 85 | 0.716 | 0.807 | 0.47 |
| No. 7 | 1.2 | 30 | 70 | 4.20 | 4.81 | 0.47 |
| No. 8 | 2.0 | 30 | 70 | 1.59 | 2.00 | 0.44 |
| No. 9 | 3.0 | 30 | 70 | 0.413 | 0.619 | 0.40 |

Table 4 indicates that, in the electrolytic solution in which the LiPF₆ concentration was 1.2 mol/L, both the diffusion coefficient of Li⁺ and the diffusion coefficient of PF₆⁻ were great. Table 4 also indicates that, in the electrolytic solution in which the proportion of ethylene carbonate was small and the proportion of methyl propionate was great, both the diffusion coefficients were great.

According to the above-described results, from the viewpoint of the diffusion coefficient of lithium ions, the electrolytic solution in which the LiPF₆ concentration is about 1.2 mol/L, the proportion of ethylene carbonate is small, and the proportion of methyl propionate is great, is considered to be preferable.

<Basic Examination 4: Charging/Discharging of Half-Cell>

LiPF₆ was dissolved at a concentration of 1.2 mol/L in a solvent obtained by mixing at a volume ratio indicated below in Table 5, to produce No. 1 to No. 4 electrolytic solutions.

TABLE 5

| | EC | MP | EP | DMC |
|---|---|---|---|---|
| No. 1 | 30 | 70 | 0 | 0 |
| No. 2 | 30 | 30 | 0 | 40 |
| No. 3 | 30 | 0 | 70 | 0 |
| No. 4 | 30 | 0 | 30 | 40 |

A positive electrode half-cell and a negative electrode half-cell were produced by using each of the electrolytic solutions in the following procedure.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 85:7.5:7.5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed to produce a positive electrode precursor. The produced positive electrode precursor was pressed in the thickness direction to produce a positive electrode having the positive electrode active material layer formed on the surface of the aluminum foil.

The weight per area of the positive electrode was 15 mg/cm².

As a counter electrode, copper foil to which lithium foil having a thickness of 0.2 μm was adhered was prepared.

As a separator, a porous polyolefin film was prepared. The positive electrode, the separator, and the counter electrode were stacked in order, respectively, to produce an electrode assembly. The electrode assembly was covered with a set of two laminate films, the laminate films were sealed at three sides, and the electrolytic solution was thereafter injected into the laminate film in a bag-like form. Thereafter, the laminate films were sealed at the remaining one side, and were thus air-tightly sealed at the four sides, to obtain a laminate-type battery in which the electrode assembly and the electrolytic solution were sealed. This battery was used as a positive electrode half-cell.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent to produce a negative electrode active material layer forming composition in a slurry form. Copper foil was prepared as a current collector for the negative electrode. The negative electrode active material layer forming composition was applied to the surface of the copper foil into a film-like form, and a solvent was thereafter removed, to produce a negative electrode precursor. The produced negative electrode precursor was pressed in the thickness direction to produce a negative electrode having the negative electrode active material layer formed on the surface of the copper foil.

The weight per area of the negative electrode was 6.15 mg/cm².

As a counter electrode, copper foil to which lithium foil having a thickness of 0.2 μm was adhered was prepared.

As a separator, a porous polyolefin film was prepared. The negative electrode, the separator, and the counter electrode were stacked in order, respectively, to produce an electrode assembly. The electrode assembly was covered with a set of two laminate films, the laminate films were sealed at the three sides, and the electrolytic solution was thereafter injected into the laminate film in a bag-like form. Thereafter, the laminate films were sealed at the remaining one side, and were thus air-tightly sealed at the four sides, to obtain a laminate-type battery in which the electrode assembly and the electrolytic solution were sealed. This battery was used as a negative electrode half-cell.

The positive electrode half-cell was charged to 4.1 V and was discharged to 2.5 V, at a constant current of 0.05 C (n=2).

The negative electrode half-cell was charged to 0.01 V and was discharged to 2.0 V, at a constant current of 0.05 C (n=2).

The discharge capacity and coulombic efficiency (=100×(discharge capacity)/(charge capacity)) obtained in the above-described test are indicated in Table 6 and Table 7.

TABLE 6

| Positive | Volume % of solvent | | |
|---|---|---|---|
| electrode | in electrolytic | Discharge | Coulombic |
| half-cell | solution | capacity | efficiency |
| No. 1 | EC30%, MP70% | 156.53 mAh/g | 97.75% |
| | | 156.28 mAh/g | 97.27% |
| No. 2 | EC30%, MP30%, | 156.46 mAh/g | 97.51% |
| | DMC40% | 156.84 mAh/g | 97.85% |
| No. 3 | EC30%, EP70% | 131.55 mAh/g | 81.41% |
| | | 134.96 mAh/g | 83.98% |
| No. 4 | EC30%, EP30%, | 155.75 mAh/g | 97.14% |
| | DMC40% | 154.92 mAh/g | 97.27% |

TABLE 7

| Negative | Volume % of solvent | | |
|---|---|---|---|
| electrode | in electrolytic | Discharge | Coulombic |
| half-cell | solution | capacity | efficiency |
| No. 1 | EC30%, MP70% | 259.91 mAh/g | 95.40% |
| | | 209.89 mAh/g | 93.48% |
| No. 2 | EC30%, MP30%, | 296.50 mAh/g | 95.97% |
| | DMC40% | 266.05 mAh/g | 94.98% |
| No. 3 | EC30%, EP70% | 147.42 mAh/g | 86.44% |
| | | 156.44 mAh/g | 88.16% |
| No. 4 | EC30%, EP30%, | 211.94 mAh/g | 93.85% |
| | DMC40% | 219.82 mAh/g | 94.03% |

In each of the positive electrode half-cell and the negative electrode half-cell, the half-cell having the electrolytic solution containing methyl propionate was considered to have excellent discharge capacity and coulombic efficiency as compared with the half-cell having the electrolytic solution containing ethyl propionate at a corresponding proportion.

In No. 3 and No. 4 half-cells having the electrolytic solution containing ethyl propionate, performance of the half-cell significantly deteriorated according to increase of ethyl propionate. However, in No. 1 and No. 2 half-cells having the electrolytic solution containing methyl propionate, deterioration of performance of the half-cell according to increase of methyl propionate was considered to be inhibited.

In addition to the result about the viscosity of the electrolytic solution in basic examination 1, usefulness of methyl propionate was considered to be supported also according to the result of charging/discharging of the positive electrode half-cell that included the positive electrode active material having an olivine structure and the negative electrode half-cell having graphite as the negative electrode active material.

### Example 1

LiPF₆ was dissolved at a concentration of 1.2 mol/L in a mixed solvent in which ethylene carbonate and methyl propionate were mixed at a volume ratio of 30:70 to produce a mother liquor. 1,3,2-dioxathiolane-2,2-dioxide (hereinafter, may be abbreviated as DTD. DTD is one mode of cyclic sulfate ester.) was added and dissolved in an amount equivalent to 0.5 mass % with respect to the mother liquor to produce an electrolytic solution of Example 1.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed to produce a negative electrode precursor. The produced negative electrode precursor was pressed in the thickness direction to produce a negative electrode having the negative electrode active material layer formed on the surface of the copper foil.

The weight per area of the negative electrode was 6.15 mg/cm², and the density of the negative electrode active material layer was 1.5 g/cm³.

As a counter electrode, copper foil to which lithium foil was adhered was prepared.

As a separator, a glass filter (Hoechst Celanese) and celgard 2400 (Polypore Inc.) as monolayer polypropylene were prepared. The separator was held between the negative electrode and the counter electrode to produce an electrode assembly. The electrode assembly was stored in a coin-type cell case CR2032 (Hohsen Corp.), and the electrolytic solution of Example 1 was further injected to obtain a coin-type cell. The coin-type cell was used as a negative electrode half-cell of Example 1.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 85:7.5:7.5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed to produce a positive electrode precursor. The produced positive electrode precursor was pressed in the thickness direction to produce a positive electrode having the positive electrode active material layer formed on the surface of the aluminum foil.

The weight per area of the positive electrode was 15 mg/cm², and the density of the positive electrode active material layer was 2.2 g/cm³.

As a counter electrode, copper foil to which lithium foil was adhered was prepared.

As a separator, a glass filter (Hoechst Celanese) and celgard 2400 (Polypore Inc.) as monolayer polypropylene were prepared. The separator was held between the positive electrode and the counter electrode to produce an electrode assembly. The electrode assembly was stored in a coin-type cell case CR2032 (Hohsen Corp.), and the electrolytic solution of Example 1 was further injected to obtain a coin-type cell. The coin-type cell was used as a positive electrode half-cell of Example 1.

### Example 2

An electrolytic solution, a negative electrode half-cell, and a positive electrode half-cell of Example 2 were produced in the same manner as in Example 1 except that lithium bis(oxalato)borate (hereinafter, may be abbreviated as LiBOB. LiBOB is one mode of oxalate borate) was used instead of DTD.

### Comparative Example 1

An electrolytic solution and a negative electrode half-cell of Comparative example 1 were produced in the same manner as in Example 1 except that DTD was not used.

### Comparative Example 2

An electrolytic solution and a negative electrode half-cell of Comparative example 2 were produced in the same manner as in Example 1 except that vinylene carbonate (hereinafter, may be abbreviated as VC.) was used instead of DTD.

### Comparative Example 3

An electrolytic solution and a negative electrode half-cell of Comparative example 3 were produced in the same manner as in Example 1 except that lithium bis(fluorosulfonyl)imide (hereinafter, may be abbreviated as LiFSI.) was used instead of DTD.

### Comparative Example 4

An electrolytic solution and a negative electrode half-cell of Comparative example 4 were produced in the same manner as in Example 1 except that 1,3-propanesultone (hereinafter, may be abbreviated as PS.) was used instead of DTD.

### Comparative Example 5

An electrolytic solution and a negative electrode half-cell of Comparative example 5 were produced in the same manner as in Example 1 except that triphenylphosphine oxide (hereinafter, may be abbreviated as TPPO.) was used instead of DTD.

### Evaluation Example 1: Initial Capacity Measurement

The negative electrode half-cells of Examples 1 to 2 and Comparative examples 1 to 5 were charged to 0.01 V and were discharged to 2.0 V, at a constant current of 0.05 C (n=2).

The result is indicated in Table 8.

TABLE 8

| | | Initial discharge |
|---|---|---|
| | Additive | capacity |
| Example 1 | DTD | 323.7 mAh/g |
| | | 321.3 mAh/g |
| Example 2 | LiBOB | 317.6 mAh/g |
| | | 319.2 mAh/g |
| Comparative | Absent | 259.9 mAh/g |
| example 1 | | 209.9 mAh/g |
| Comparative | VC | 288.7 mAh/g |
| example 2 | | 280.1 mAh/g |
| Comparative | LiFSI | 293.3 mAh/g |
| example 3 | | 294.5 mAh/g |
| Comparative | PS | 241.3 mAh/g |
| example 4 | | 239.1 mAh/g |
| Comparative | TPPO | 234.5 mAh/g |
| example 5 | | 272.5 mAh/g |

The result in Table 8 indicates that the discharge capacity of the negative electrode half-cell of each of Example 1 and Example 2 was significantly greater than the discharge capacity of the negative electrode half-cell of each of Comparative example 1 to Comparative example 5. DTD as cyclic sulfate ester and LiBOB as oxalate borate were considered to be preferable as the additive of the electrolytic solution of the lithium ion secondary battery having graphite as the negative electrode active material.

### Evaluation Example 2: Reductive Degradation Potential Measurement

The negative electrode half-cell of each of Examples 1 to 2 and Comparative examples 1 to 3 was charged to 0.01 V at a constant current of 0.05 C. A graph in which the horizontal axis represents values of a potential V (vsLi/Li⁺) and the vertical axis represents values obtained by differentiating a charge capacity Q with the potential V was generated based on the obtained charge curve of each of the negative electrode half-cells.

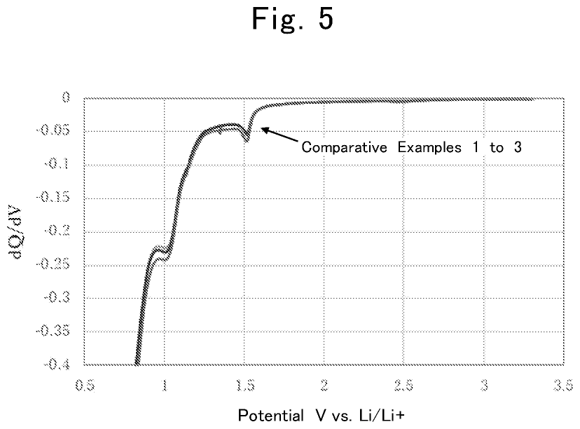

In FIG. 4, the graphs for the negative electrode half-cells of Example 1, Example 2, and Comparative example 1 overlap each other. In FIG. 5, the graphs for the negative electrode half-cells of Comparative example 1 to Comparative example 3 overlap each other.

According to the graph for the negative electrode half-cell of Comparative example 1 in FIG. 4, the potential at which one of LiPF₆, ethylene carbonate, and methyl propionate started reductive degradation was considered to be around 1.52 V. According to LUMO levels and reductive degradation potentials of the components, and a state in the electrolytic solution, a part of ethylene carbonate coordinated with lithium ions in a state where the LUMO level was reduced, was assumed to preferentially start the reductive degradation around 1.52 V.

The graphs for the negative electrode half-cells of Example 1 and Example 2 indicate that a downward projecting peak appears at a potential higher than 1.52 V. The peak of the negative electrode half-cell of Example 1 was considered to be caused by reductive degradation of DTD, and the peak of the negative electrode half-cell of Example 2 was considered to be caused by reductive degradation of LiBOB. Therefore, in the negative electrode half-cells of Example 1 and Example 2, reductive degradation of DTD and LiBOB was considered to occur earlier than reductive degradation of other components.

Meanwhile, the graphs for the negative electrode half-cells of Comparative example 1 to Comparative example 3 were similar to each other. According to the result, in the negative electrode half-cells of Comparative example 2 and Comparative example 3, reductive degradation of a component, other than vinylene carbonate, contained in the electrolytic solution, or a component, other than LiFSI, contained in the electrolytic solution was considered to occur firstly. Therefore, an SEI coating derived from a component, other than vinylene carbonate and LiFSI, contained in the electrolytic solution was considered to be preferentially formed on the surface of the negative electrode.

The difference in the reductive degradation behavior of the component of the electrolytic solution as described above was considered to exert an influence on a value of discharge capacity of the lithium ion secondary battery having graphite as the negative electrode active material. That is, the SEI coating derived from reductive degradation of DTD and LiBOB was excellent, so that the discharge capacity of the negative electrode half-cell of each of Example 1 and Example 2 was considered to be great.

### Evaluation Example 3: Measurement of Initial Capacity of Positive Electrode Half-Cell

The positive electrode half-cells of Example 1 and Example 2 were charged to 4.1 V and were discharged to 3.0 V, at a constant current of 0.05 C (n=2).

The result is indicated in Table 9.

TABLE 9

| | | Initial charge | Initial discharge |
|---|---|---|---|
| | Additive | capacity | capacity |
| Example 1 | DTD | 159.7 mAh/g | 159.5 mAh/g |
| | | 159.9 mAh/g | 159.7 mAh/g |
| Example 2 | LiBOB | 159.8 mAh/g | 159.7 mAh/g |
| | | 159.7 mAh/g | 159.4 mAh/g |

The result in Table 9 indicates that both the initial charge capacities and the initial discharge capacities of the positive electrode half-cells of Example 1 and Example 2 were great and almost equal to each other. The positive electrode half-cells of Example 1 and Example 2 were considered to be advantageously charged/discharged.

The electrolytic solution of the present invention is considered to be suitable as an electrolytic solution of the lithium ion secondary battery that includes the positive electrode active material having an olivine structure.

### Example 3

LiPF₆ was dissolved at a concentration of 1.2 mol/L in a mixed solvent in which ethylene carbonate and methyl propionate were mixed at a volume ratio of 15:85 to produce a mother liquor. DTD was added and dissolved in an amount equivalent to 0.5 mass % with respect to the mother liquor to produce an electrolytic solution of Example 3.

A positive electrode half-cell and a negative electrode half-cell of Example 3 were produced in the same manner as in Example 1 except that the electrolytic solution of Example 3 was used.

### Comparative Example 6

LiPF₆ was dissolved at a concentration of 1.2 mol/L in methyl propionate to produce a mother liquor. DTD was added and dissolved in an amount equivalent to 0.5 mass % with respect to the mother liquor to produce an electrolytic solution of Comparative example 6.

A positive electrode half-cell and a negative electrode half-cell of Comparative example 6 were produced in the same manner as in Example 1 except that the electrolytic solution of Comparative example 6 was used

### Evaluation Example 4: Charging/Discharging Test in Each Half-Cell

The positive electrode half-cells of Example 1, Example 3, and Comparative example 6 were charged to 4.1 V and were discharged to 2.5 V, at a constant current of 0.05 C.

The negative electrode half-cells of Example 1, Example 3, and Comparative example 6 were charged to 0.01 V and were discharged to 2.0 V, at a constant current of 0.05 C.

The result of the above-described test is indicated in Table 10.

TABLE 10

| | | Positive | Negative |
|---|---|---|---|
| | | electrode half- | electrode half- |
| | | cell Upper part: | cell Upper part: |
| | Volume % of | charge capacity | charge capacity |
| | solvent of | Lower part: | Lower part: |
| | electrolytic | discharge | discharge |
| | solution | capacity | capacity |
| Example 1 | EC30%, MP70% | 160 mAh/g | 304 mAh/g |
| | | 159 mAh/g | 301 mAh/g |
| Example 3 | EC15%, MP85% | 163 mAh/g | 295 mAh/g |
| | | 160 mAh/g | 291 mAh/g |
| Comparative | MP100% | 168 mAh/g | 20 mAh/g |
| example 6 | | 158 mAh/g | 30 mAh/g |

The positive electrode half-cells of Example 1 and Example 3 were considered to be reversibly charged/discharged according to the numerical values of the charge capacity and the discharge capacity for the positive electrode half-cell indicated in Table 10. The positive electrode half-cell of Comparative example 6 which included the electrolytic solution having no ethylene carbonate was also considered to be reversibly charged/discharged although a proportion of the discharge capacity to the charge capacity was reduced.

The negative electrode half-cells of Example 1 and Example 3 were considered to be reversibly charged/discharged according to the numerical values of the charge capacity and the discharge capacity for the negative electrode half-cell indicated in Table 10. Meanwhile, the negative electrode half-cell of Comparative example 6 which included the electrolytic solution having no ethylene carbonate was considered to be hardly charged.

The above-described result indicates that cyclic carbonate such as ethylene carbonate as well as the additive of the present invention was considered to be necessary for the electrolytic solution of the lithium ion secondary battery having graphite as the negative electrode active material.

### Example 4

The lithium ion secondary battery of Example 4 was produced by using the electrolytic solution of Example 1 as follows.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 90:5:5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed to produce a positive electrode precursor. The produced positive electrode precursor was pressed in the thickness direction to produce a positive electrode having the positive electrode active material layer formed on the surface of the aluminum foil.

In the production of the positive electrode, the target weight per area of the positive electrode was 13.87 mg/cm², and the target density of the positive electrode active material layer was 2 g/cm³.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

In the production of the negative electrode, the target weight per area of the negative electrode was 6.27 mg/cm², and the target density of the negative electrode active material layer was 1.55 g/cm³.

As a separator, a porous polypropylene film was prepared. The separator was held between the positive electrode and the negative electrode to produce an electrode assembly. The electrode assembly was put and sealed together with the electrolytic solution of Example 1 in a laminate film in a bag-like form to produce a lithium ion secondary battery of Example 4.

### Example 5

A lithium ion secondary battery of Example 5 was produced in the same manner as in Example 4 except that the electrolytic solution of Example 2 was used.

### Comparative Example 7

Ethylene carbonate, ethyl methyl carbonate, and dimethyl carbonate were mixed at a volume ratio of 30:30:40 to produce a mixed solvent. LiPF₆ and LiFSI were dissolved in the mixed solvent to produce a mother liquor in which the LiPF₆ concentration was 1 mol/L and the LiFSI concentration was 0.1 mol/L. Vinylene carbonate was added in an amount equivalent to 0.2 mass % with respect to the mother liquor, to produce an electrolytic solution of Comparative example 7.

A lithium ion secondary battery of Comparative example 7 was produced in the same manner as in Example 4 except that the electrolytic solution of Comparative example 7 was used.

### Evaluation Example 5: Initial Capacity and Output Test

The lithium ion secondary batteries of Example 4, Example 5, and Comparative example 7 were charged to 4.0 V at a constant current of 0.4 C and were then subjected to a constant voltage charging for maintaining the voltage, and were thereafter discharged to 2.5 V at a constant current of 1 C and were then subjected to a constant voltage discharging for maintaining the voltage. The observed discharge capacity for each positive electrode active material was defined as an initial capacity. The test for the initial capacity was performed a plurality of times.

A voltage change amount was measured when the lithium ion secondary batteries of Example 4, Example 5, and Comparative example 7 in which the SOC was adjusted to 60% were discharged at a constant current rate for 10 seconds under a condition of 25° C. The measurement was performed under a plurality of conditions generated by changing the current rate. A constant current (mA) at which a time for discharging to a voltage of 2.5 V was 10 seconds was calculated for each lithium ion secondary battery having the SOC of 60% according to the obtained results. A value obtained by multiplying the voltage change amount in change from the SOC of 60% to 2.5 V, by the calculated constant current, was defined as an initial output. The test for the initial output was also performed a plurality of times.

The average value of the results is indicated in Table 11.

TABLE 11

| | | Initial | Initial |
|---|---|---|---|
| | Electrolytic solution | capacity | output |
| Example 4 | Main solvent: MP | 142.8 mAh/g | 1100.5 mW |
| | Additive: DTD | | |
| Example 5 | Main solvent: MP | 142.2 mAh/g | 987.7 mW |
| | Additive: LiBOB | | |
| Comparative | Main solvent: dimethyl | 143.0 mAh/g | 996.8 mW |
| example 7 | carbonate | | |
| | Additive: LiFSI and VC | | |

The result in Table 11 indicates that the lithium ion secondary battery that included the positive electrode active material having an olivine structure, graphite as the negative electrode active material, and the electrolytic solution of the present invention was considered to exhibit an initial capacity and an initial output equivalent to those of the lithium ion secondary battery having a conventional electrolytic solution. The initial output of the lithium ion secondary battery was considered to be significantly enhanced by including the electrolytic solution containing, as the additive, DTD as cyclic sulfate ester.

### Example 6

A lithium ion secondary battery of Example 6 was produced in the same manner as in Example 4 except that the electrolytic solution of Example 3 was used.

### Example 7

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 0.5 mass % with respect to the mother liquor and lithium difluoro(oxalato)borate (hereinafter, may be abbreviated as LiDFOB. LiDFOB is one mode of oxalate borate.) in an amount equivalent to 1 mass % with respect to the mother liquor were added and dissolved to produce an electrolytic solution of Example 7.

A lithium ion secondary battery of Example 7 was produced in the same manner as in Example 4 except that the electrolytic solution of Example 7 was used.

### Example 8

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 0.5 mass % with respect to the mother liquor and LiFSI in an amount equivalent to 1 mass % with respect to the mother liquor were added and dissolved to produce an electrolytic solution of Example 8.

A lithium ion secondary battery of Example 8 was produced in the same manner as in Example 4 except that the electrolytic solution of Example 8 was used.

### Example 9

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 0.5 mass % with respect to the mother liquor and fluoroethylene carbonate (hereinafter, may be abbreviated as FEC) in an amount equivalent to 1 mass % with respect to the mother liquor were added and dissolved to produce an electrolytic solution of Example 9.

A lithium ion secondary battery of Example 9 was produced in the same manner as in Example 4 except that the electrolytic solution of Example 9 was used.

### Example 10

LiPF₆ was dissolved at a concentration of 1.2 mol/L in a mixed solvent in which ethylene carbonate and methyl propionate were mixed at a volume ratio of 15:85 to produce a mother liquor. LiDFOB in an amount equivalent to 1 mass % with respect to the mother liquor and vinylene carbonate in an amount equivalent to 1 mass % with respect to the mother liquor were added and dissolved to produce an electrolytic solution of Example 10.

A lithium ion secondary battery of Example 10 was produced in the same manner as in Example 4 except that the electrolytic solution of Example 10 was used

### Example 11

LiPF₆ was dissolved at a concentration of 1.2 mol/L in a mixed solvent in which ethylene carbonate and methyl propionate were mixed at a volume ratio of 15:85 to produce a mother liquor. LiDFOB in an amount equivalent to 1 mass % with respect to the mother liquor and fluoroethylene carbonate in an amount equivalent to 1 mass % with respect to the mother liquor were added and dissolved to produce an electrolytic solution of Example 11.

A lithium ion secondary battery of Example 11 was produced in the same manner as in Example 4 except that the electrolytic solution of Example 11 was used.

### Evaluation Example 6: Initial Capacity and Output Test

The test for the lithium ion secondary batteries of Examples 6 to 11 was performed in the same method as in Evaluation example 5. The average value of the results is indicated in Table 12.

TABLE 12

| | | Initial | Initial |
|---|---|---|---|
| | Additive | capacity | output |
| Example 6 | DTD | 135.8 mAh/g | 757.3 mW |
| Example 7 | DTD and LiDFOB | 138.3 mAh/g | 790.2 mW |
| Example 8 | DTD and LiFSI | 137.4 mAh/g | 765.7 mW |
| Example 9 | DTD and FEC | 136.8 mAh/g | 920.4 mW |
| Example 10 | LiDFOB and VC | 139.2 mAh/g | 982.1 mW |
| Example 11 | LiDFOB and FEC | 137.7 mAh/g | 931.7 mW |

The result in Table 12 indicates that, by using DTD as cyclic sulfate ester and LiDFOB as oxalate borate in combination or by adding, to the electrolytic solution, another additive in addition to DTD as cyclic sulfate ester or LiDFOB as oxalate borate, performance of the lithium ion secondary battery that included the positive electrode active material having an olivine structure and graphite as the negative electrode active material, was considered to be further enhanced.

### Example 12

LiPF₆ was dissolved at a concentration of 1.2 mol/L in a mixed solvent in which ethylene carbonate and methyl propionate were mixed at a volume ratio of 30:70 to produce a mother liquor. Fluoroethylene carbonate in an amount equivalent to 2 mass % with respect to the mother liquor and DTD in an amount equivalent to 1 mass % with respect to the mother liquor were added and dissolved to produce an electrolytic solution of Example 12.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

The weight per area of the negative electrode was 9 mg/cm².

Lithium foil was prepared as a counter electrode.

As a separator, a glass filter (Hoechst Celanese) and celgard 2400 (Polypore Inc.) as a monolayer polypropylene were prepared. The separator was held between the negative electrode and the counter electrode to produce an electrode assembly. The electrode assembly was stored in a coin-type cell case CR2032 (Hohsen Corp.), and the electrolytic solution of Example 12 was further injected to obtain a coin-type cell. The coin-type cell was used as a negative electrode half-cell of Example 12.

### Example 13

LiPF₆ was dissolved at a concentration of 1.2 mol/L in a mixed solvent in which ethylene carbonate and methyl propionate were mixed at a volume ratio of 30:70 to produce a mother liquor. Vinylene carbonate in an amount equivalent to 2 mass % with respect to the mother liquor and DTD in an amount equivalent to 1 mass % with respect to the mother liquor were added and dissolved to produce an electrolytic solution of Example 13.

A lithium ion secondary battery of Example 13 was produced in the same manner as in Example 12 except that the electrolytic solution of Example 13 was used.

### Example 14

LiPF₆ was dissolved at a concentration of 1.2 mol/L in a mixed solvent in which ethylene carbonate and methyl propionate were mixed at a volume ratio of 30:70 to produce a mother liquor. DTD in an amount equivalent to 1 mass % with respect to the mother liquor was added and dissolved to produce an electrolytic solution of Example 14.

A lithium ion secondary battery of Example 14 was produced in the same manner as in Example 12 except that the electrolytic solution of Example 14 was used.

### Example 15

LiPF₆ was dissolved at a concentration of 1.2 mol/L in a mixed solvent in which ethylene carbonate and methyl propionate were mixed at a volume ratio of 30:70 to produce a mother liquor. LiDFOB in an amount equivalent to 1 mass % with respect the mother liquor was added and dissolved to produce an electrolytic solution of Example 15.

A lithium ion secondary battery of Example 15 was produced in the same manner as in Example 12 except that the electrolytic solution of Example 15 was used.

### Comparative Example 8

A lithium ion secondary battery of Comparative example 8 was produced in the same manner as in Example 12 except that the mother liquor was used as the electrolytic solution.

### Evaluation Example 7: Charging/Discharging Cycle Test and Resistance During Charging

The lithium ion secondary batteries of Examples 12 to 15 and Comparative example 8 were charged to 0.01 V at a current of 0.065 C and discharged to 1 V. Thereafter, a charging and discharging cycle in which the lithium ion secondary battery was charged to 0.01 V at a current of 0.16 C, application of voltage was thereafter stopped for 10 seconds, and the lithium ion secondary battery was continuously discharged to 1 V, was repeated 50 times.

A percentage of a discharge capacity in the 50th charging and discharging cycle to a discharge capacity in the first charging and discharging cycle was defined as a capacity retention rate.

A resistance was calculated from a current value and a voltage change amount obtained until application of voltage was stopped at 0.01 V for 10 seconds, for each charging and discharging cycle. A percentage of a resistance at the 50th charging and discharging cycle to a resistance at the first charging and discharging cycle was defined as a resistance increase rate.

The results about the capacity retention rate and the resistance increase rate are indicated in Table 13.

TABLE 13

| | | Capacity | Resistance |
|---|---|---|---|
| | | retention | increase |
| | Additive | rate | rate |
| Example 12 | DTD and FEC | 100.6% | 107% |
| Example 13 | DTD and VC | 98.0% | 116% |
| Example 14 | DTD | 9.2% | 115% |
| Example 15 | LiDFOB | 24.3% | 130% |
| Comparative | Absent | 8.9% | 140% |
| example 8 | | | |

The result in Table 13 indicates that, in the electrolytic solution in which both DTD as cyclic sulfate ester and fluoroethylene carbonate as fluorine-containing cyclic carbonate were used in combination, and the electrolytic solution in which both DTD as cyclic sulfate ester and vinylene carbonate as unsaturated cyclic carbonate were used in combination, the capacity of the lithium ion secondary battery having graphite as the negative electrode active material was advantageously retained and increase of resistance was inhibited.

The results of Example 14, Example 15, and Comparative example 8 indicate that an effect obtained by adding alone DTD that was cyclic sulfate ester or LiDFOB that was oxalate borate, as the additive, was confirmed to some degree although the degree was low, as compared with the electrolytic solution having no additive.

### Example 16

LiPF₆ was dissolved at a concentration of 1.0 mol/L in a mixed solvent in which ethylene carbonate and methyl propionate were mixed at a volume ratio of 15:85 to produce a mother liquor. DTD in an amount equivalent to 0.5 mass % with respect to the mother liquor was added and dissolved to produce an electrolytic solution of Example 16.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 90:5:5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil in a film-like form, and the solvent was thereafter removed to produce a positive electrode precursor. The produced positive electrode precursor was pressed in the thickness direction to produce a positive electrode having the positive electrode active material layer formed on the surface of the aluminum foil.

The weight per area of the positive electrode was 92 mg/cm².

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

The weight per area of the negative electrode was 43 mg/cm².

A porous polypropylene film was prepared as a separator. The separator was held between the positive electrode and the negative electrode to produce an electrode assembly. The electrode assembly was put and sealed together with the electrolytic solution of Example 16 in a laminate film in a bag-like form to produce a lithium ion secondary battery of Example 16.

### Comparative Example 9

Ethylene carbonate, fluoroethylene carbonate, ethyl methyl carbonate, and dimethyl carbonate were mixed at a volume ratio of 20:5:35:40 to produce a mixed solvent. LiPF₆ was dissolved in the mixed solvent to produce an electrolytic solution of Comparative example 9 in which the LiPF₆ concentration was 1.2 mol/L.

A lithium ion secondary battery of Comparative example 9 was produced in the same manner as in Example 16 except that the electrolytic solution of Comparative example 9 was used.

### Evaluation Example 8: Charging/Discharging Test for Thickly Coated Electrode

The lithium ion secondary batteries of Example 16 and Comparative example 9 were charged to 3.75 V at 0.05 C and discharged to 3.0 V at 0.33 C. The obtained discharge capacity is indicated in Table 14.

A voltage change amount was measured when the lithium ion secondary batteries of Example 16 and Comparative example 9 in which the SOC was adjusted to 5% were discharged at a constant current rate for 5 seconds under a condition of 25° C. The measurement was performed under a plurality of conditions generated by changing the current rate. A constant current at which a time for discharging to a voltage of 2.23 V was 5 seconds was calculated for each lithium ion secondary battery having the SOC of 5% according to the obtained results. A value obtained by multiplying the voltage change amount in change from the SOC of 5% to 2.23 V, by the calculated constant current, was defined as an output at the SOC of 5%. The output at the SOC of 5% is indicated in Table 14.

The lithium ion secondary batteries of Example 16 and Comparative example 9 in which the SOC was adjusted to 95% were discharged to a voltage of 2.23 V at a current of 1.1 C under a condition of 25° C. or 40° C. The measured discharge capacity (high rate discharge capacity) and % of the discharge capacity in terms of the SOC are indicated in Table 14 for each temperature condition.

TABLE 14

| | | | High rate | % in | High rate | % in |
|---|---|---|---|---|---|---|
| | | Output | discharge | terms | discharge | terms |
| | Discharge | at SOC | capacity | of SOC | capacity | of SOC |
| | capacity | of 5% | at 25° C. | at 25° C. | at 40° C. | at 40° C. |
| Example 16 | 87.39 mAh | 956.3 mW | 19.34 mAh | 22.13% | 25.46 mAh | 29.13% |
| Comparative | 89.09 mAh | 851.3 mW | 14.33 mAh | 16.09% | 22.65 mAh | 25.42% |
| example 9 | | | | | | |

The lithium ion secondary battery of Example 16 and the lithium ion secondary battery of Comparative example 9 were each a lithium ion secondary battery in which a thickly coated electrode having a great weight per area was used as each of the positive electrode and the negative electrode.

The result in Table 14 indicates that the lithium ion secondary battery of Example 16 had excellent output characteristics at a high rate as compared with the lithium ion secondary battery of Comparative example 9 having a conventional electrolytic solution.

In the lithium ion secondary battery that included both the thickly coated positive electrode which had the positive electrode active material having an olivine structure and the thickly coated negative electrode having graphite as the negative electrode active material, the electrolytic solution of the present invention was considered to be able to inhibit reduction of a capacity due to high rate discharging to a certain degree.

### Example 17

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 1 mass % with respect to the mother liquor was added and dissolved to produce an electrolytic solution of Example 17.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 90:5:5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed, to produce a positive electrode precursor. The produced positive electrode precursor was pressed in the thickness direction to produce a positive electrode having the positive electrode active material layer formed on the surface of the aluminum foil.

The weight per area of the positive electrode was about 13.9 mg/cm².

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

The weight per area of the negative electrode was about 6.2 mg/cm².

A porous polypropylene film was prepared as a separator. The separator was held between the positive electrode and the negative electrode to produce an electrode assembly. The electrode assembly was put and sealed together with the electrolytic solution of Example 17 in a laminate film in a bag-like form to produce a lithium ion secondary battery of Example 17.

### Example 18

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 1 mass % with respect to the mother liquor and fluoroethylene carbonate in an amount equivalent to 1 mass % with respect to the mother liquor were added and dissolved to produce an electrolytic solution of Example 18.

A lithium ion secondary battery of Example 18 was produced in the same manner as in Example 17 except that the electrolytic solution of Example 18 was used.

### Example 19

LiPF₆ was dissolved at a concentration of 1.2 mol/L in a mixed solvent in which ethylene carbonate and methyl propionate were mixed at a volume ratio of 15:85 to produce a mother liquor. LiDFOB in an amount equivalent to 1 mass % with respect to the mother liquor was added and dissolved to produce an electrolytic solution of Example 19.

A lithium ion secondary battery of Example 19 was produced in the same manner as in Example 17 except that the electrolytic solution of Example 19 was used.

### Example 20

A lithium ion secondary battery of Example 20 was produced in the same manner as in Example 17 except that the electrolytic solution of Example 11 was used.

### Example 21

A lithium ion secondary battery of Example 21 was produced in the same manner as in Example 17 except that the electrolytic solution of Example 10 was used.

### Comparative Example 10

Ethylene carbonate, ethyl methyl carbonate, and dimethyl carbonate were mixed at a volume ratio of 30:30:40 to produce a mixed solvent. LiPF₆, LiFSI, and LiDFOB were dissolved in the mixed solvent to produce a mother liquor in which LiPF₆ concentration was 1 mol/L, the LiFSI concentration was 0.1 mol/L, and the LiDFOB concentration was 0.2 mol/L. Vinylene carbonate in an amount equivalent to 1 mass % with respect to the mother liquor was added and dissolved to produce an electrolytic solution of Comparative example 10.

A lithium ion secondary battery of Comparative example 10 was produced in the same manner as in Example 17 except that the electrolytic solution of Comparative example 10 was used.

### Evaluation Example 9: High Temperature Charging/Discharging Cycle Test

For the lithium ion secondary batteries of Examples 17 to 21 and Comparative example 10, a high temperature charging/discharging cycle test was performed.

[Confirmation of Capacity]

Firstly, prior to the high temperature charging/discharging cycle test, CC-CV charging to 4.0 V was performed at a rate of 0.4 C. Subsequently, CC-CV discharging to 2.5 V was performed at a rate of 1 C. Thus, a discharge capacity of each of the lithium ion secondary batteries was confirmed.

[High Temperature Charging/Discharging Cycle]

Thereafter, a high temperature charging/discharging cycle in which CC-CV charging to 4.0 V was performed at 60° C. at a rate of 0.4 C, and CC discharging to 2.5 V or to the SOD of 90% was performed at a rate of 1 C, was repeated 50 times. In the description herein, the charging means that lithium ions are moved from the negative electrode to the positive electrode and a potential difference between the positive electrode and the negative electrode is increased.

After end of the 50-th charging/discharging, a capacity of each lithium ion secondary battery was confirmed similarly to the above-described confirmation of the capacity. A percentage of the discharge capacity after the high temperature charging/discharging cycle to the discharge capacity before the high temperature charging/discharging cycle was defined as a capacity retention rate of each lithium ion secondary battery. The result of the high temperature charging/discharging cycle test is indicated in Table 15. The test was performed at n=2, and the average value in the tests is indicated in Table 15.

TABLE 15

| | | | Capacity |
|---|---|---|---|
| | Nonaqueous | | retention |
| | solvent | Additive | rate |
| Example 17 | EC and MP | DTD | 87.2% |
| Example 18 | EC and MP | DTD and FEC | 87.3% |
| Example 19 | EC and MP | LiDFOB | 89.2% |
| Example 20 | EC and MP | LiDFOB and FEC | 93.5% |
| Example 21 | EC and MP | LiDFOB and VC | 94.3% |
| Comparative | EC, EMC, and | LiDFOB and VC | 94.3% |
| example 10 | DMC | | |

As indicated in Table 15, the capacity retention rate of the lithium ion secondary battery at a high temperature was enhanced in a case where LiDFOB as oxalate borate was used as the additive of the electrolytic solution, as compared with a case where DTD as cyclic sulfate ester was used as the additive. In the table, in a case where fluoroethylene carbonate as fluorine-containing cyclic carbonate or vinylene carbonate as unsaturated cyclic carbonate was used in combination with LiDFOB, the capacity retention rate of the lithium ion secondary battery at a high temperature was further enhanced.

Particularly, in a case where vinylene carbonate was used in combination with LiDFOB, the capacity retention rate of the lithium ion secondary battery at a high temperature was enhanced to the same or higher degree as compared with Comparative example 10 in which a carbonate-based nonaqueous solvent was used instead of methyl propionate as the nonaqueous solvent.

### Evaluation Example 10: Storage Test

For the lithium ion secondary batteries of Examples 17 to 21 and Comparative example 10, CC-CV charging to 4.0 V was performed at a rate of 0.4 C, and a charge capacity at this time was defined as a reference (SOC of 100%). A storage test in which each of the lithium ion secondary batteries at the SOC of 100 was stored at 40° C. for 14 days, was performed.

Before and after the storage test, similarly to Evaluation example 9, the capacity was confirmed, and a percentage of the discharge capacity after the storage test to the discharge capacity before the storage test was defined as a capacity retention rate of each lithium ion secondary battery. The result of the storage test is indicated in Table 16. The test was performed at n=2, and the average value in the tests is indicated in Table 16.

TABLE 16

| | | | Capacity |
|---|---|---|---|
| | Nonaqueous | | retention |
| | solvent | Additive | rate |
| Example 17 | EC and MP | DTD | 94.3% |
| Example 18 | EC and MP | DTD and FEC | 93.5% |
| Example 19 | EC and MP | LiDFOB | 93.9% |
| Example 20 | EC and MP | LiDFOB and FEC | 95.0% |
| Example 21 | EC and MP | LiDFOB and VC | 96.1% |
| Comparative | EC, EMC, and | LiDFOB and VC | 95.9% |
| example 10 | DMC | | |

As indicated in Table 16, also in the storage test, similarly to the high temperature charging/discharging cycle test, in a case where LiDFOB as oxalate borate was used as the additive of the electrolytic solution, the capacity retention rate of the lithium ion secondary battery after storage at 40° C. was enhanced, and, in a case where fluoroethylene carbonate or vinylene carbonate was used in combination with LiDFOB, the capacity retention rate was further enhanced. Particularly, in a case where vinylene carbonate was used in combination as LiDFOB, the capacity retention rate of the lithium ion secondary battery after storage at 40° C. was enhanced to the same or higher degree as compared with Comparative example 10 in which a carbonate-based nonaqueous solvent was used as the nonaqueous solvent.

### Example 22

LiPF₆ was dissolved at a concentration of 1.2 mol/L in a mixed solvent in which ethylene carbonate and methyl propionate were mixed at a volume ratio of 15:85 to produce a mother liquor. DTD in an amount equivalent to 1 mass % with respect to the mother liquor and vinylene carbonate in an amount equivalent to 1 mass % with respect to the mother liquor were added and dissolved to produce an electrolytic solution of Example 22.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil in a film-like form, and the solvent was thereafter removed to produce a negative electrode precursor. The produced negative electrode precursor was pressed in the thickness direction to produce a negative electrode having the negative electrode active material layer formed on the surface of the copper foil.

The weight per area of the negative electrode was 6.3 mg/cm², and the density of the negative electrode active material layer was 1.5 g/cm³.

As a counter electrode, copper foil to which lithium foil having a thickness of 0.2 μm was adhered was prepared.

As a separator, a porous polyolefin film was prepared. The negative electrode, the separator, and the counter electrode were stacked in order, respectively, to produce an electrode assembly. The electrode assembly was covered with a set of two laminate films, the laminate films were sealed at the three sides, and the electrolytic solution was thereafter injected into the laminate film in a bag-like form. Thereafter, the laminate films were sealed at the remaining one side, and were thus air-tightly sealed at the four sides, to obtain a laminate-type battery in which the electrode assembly and the electrolytic solution were sealed. This battery was used as a negative electrode half-cell of Example 22.

### Example 23

A negative electrode half-cell of Example 23 was produced in the same manner as in Example 22 except that the electrolytic solution of Example 10 was used.

### Evaluation Example 11: Analysis of Negative Electrode Coating

For the negative electrode half-cells of Examples 22 and 23, the potential was gradually changed by a linear sweep voltammetry method and a negative electrode component that was thereafter formed at the negative electrode was analyzed.

Firstly, each negative electrode half-cell was gradually charged from an open circuit potential to 0.01 V at 0.054 mV/second. Subsequently, each negative electrode half-cell was retained at a constant voltage of 0.01 V for one hour, and, thereafter, was gradually discharged from 0.01 V to 1.0 V at 0.054 mV/second.

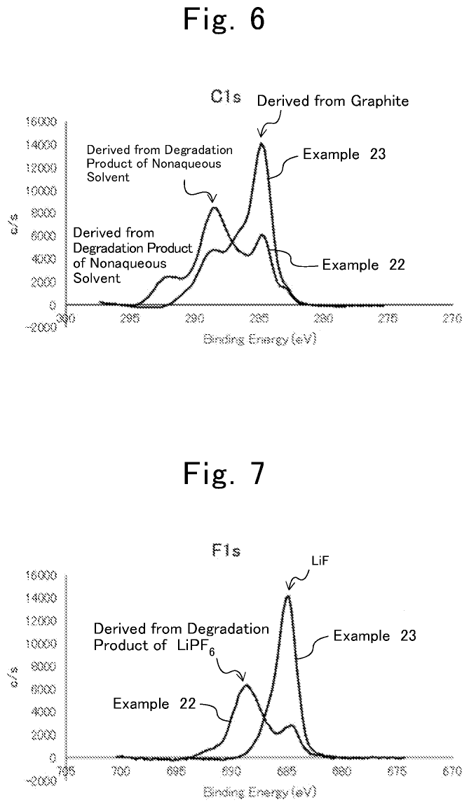

After the linear sweep voltammetry, each negative electrode half-cell was disassembled in a glovebox in an Ar atmosphere, and the negative electrode was taken out. The taken-out negative electrode was cleaned, and analyzed by X-ray photoelectron spectroscopy (XPS). The result is shown in FIGS. 6 and 7. Hereinafter, as necessary, the negative electrode in the negative electrode half-cell of Example 22 is referred to as the negative electrode of Example 22, and the negative electrode in the negative electrode half-cell of Example 23 is referred to as the negative electrode of Example 23.

As shown in FIG. 6, a plurality of peaks derived from carbon were found in C1s spectra of the negative electrode of Example 22 and the negative electrode of Example 23. Among the peaks, a peak near 291 to 294 eV and a peak near 287 to 290 eV considered to be derived from a degradation product of the nonaqueous solvent of the electrolytic solution were relatively great in the negative electrode of Example 22 and relatively small in the negative electrode of Example 23.

A peak near 285 eV considered to be derived from graphite was relatively small in the negative electrode of Example 22 and relatively great in the negative electrode of Example 23. This means that the coating formed in the negative electrode of Example 22 was relatively thick and the coating formed in the negative electrode of Example 23 was relatively thin.

In consideration of these results, in the negative electrode half-cell of Example 23 in which LiDFOB was used as the additive of the electrolytic solution, degradation of the nonaqueous solvent contained in the electrolytic solution was inhibited, so that a thin coating was assumed to be formed in the negative electrode, as compared with the negative electrode half-cell of Example 22 in which DTD was used as the additive of the electrolytic solution.

As shown in FIG. 7, a plurality of peaks derived from fluorine were found in F1s spectra of the negative electrode of Example 22 and the negative electrode of Example 23. Among the peaks, a peak near 687 to 690 eV considered to be derived from a degradation product of LiPF₆ as a salt of the electrolytic solution was relatively great in the negative electrode of Example 22 and relatively small in the negative electrode of Example 23.

A peak near 685 eV considered to be derived from LiF was relatively small in the negative electrode of Example 22 and relatively great in the negative electrode of Example 23.

In consideration of these results, in the negative electrode half-cell of Example 23 in which LiDFOB was used as the additive of the electrolytic solution, degradation of LiPF₆ contained in the electrolytic solution was inhibited, and, furthermore, coating containing a large amount of LiF was considered to be formed, as compared with the negative electrode half-cell of Example 22 in which DTD was used as the additive of the electrolytic solution.

As described above, when the lithium ion secondary battery of the present invention is charged, an SEI coating derived from reductive degradation of the additive of the present invention is considered to be preferentially formed on the surface of the negative electrode. The SEI coating containing a large amount of LiF is considered to be advantageous for inhibiting degradation of a component of the electrolytic solution. Therefore, by using LiDFOB as the additive of the electrolytic solution, further enhancement of performance of the SEI coating formed in the negative electrode is expected.

### Example 24

LiPF₆ was dissolved at a concentration of 1.2 mol/L in a mixed solvent in which ethylene carbonate and methyl propionate were mixed at a volume ratio of 15:85 to produce a mother liquor. LiBOB in an amount equivalent to 1 mass % with respect to the mother liquor and vinylene carbonate in an amount equivalent to 1 mass % with respect to the mother liquor were added and dissolved to produce an electrolytic solution of Example 24.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 90:5:5, and N-methyl-2-pyrrolidone was added as a solvent, to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed, to produce a positive electrode precursor. The produced positive electrode precursor was pressed in the thickness direction to produce a positive electrode having the positive electrode active material layer formed on the surface of the aluminum foil.

In the production of the positive electrode, the target weight per area of the positive electrode was 13.9 mg/cm², and the target density of the positive electrode active material layer was 2 g/cm³.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

In the production of the negative electrode, the target weight per area of the negative electrode was 6.3 mg/cm², and the target density of the negative electrode active material layer was 1.3 g/cm³.

A porous polypropylene film was prepared as a separator. The separator was held between the positive electrode and the negative electrode to produce an electrode assembly. The electrode assembly was put and sealed together with the electrolytic solution of Example 24 in a laminate film in a bag-like form to produce a lithium ion secondary battery of Example 24.

### Example 25

LiPF₆ was dissolved at a concentration of 1.2 mol/L in a mixed solvent in which ethylene carbonate and methyl propionate were mixed at a volume ratio of 15:85 to produce a mother liquor. LiBOB in an amount equivalent to 1 mass % with respect to the mother liquor and fluoroethylene carbonate in an amount equivalent to 1 mass % with respect to the mother liquor were added and dissolved to produce an electrolytic solution of Example 25.

A lithium ion secondary battery of Example 25 was produced in the same manner as in Example 24 except that the electrolytic solution of Example 25 was used.

### Example 26

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor was added and dissolved to produce an electrolytic solution of Example 26.

A lithium ion secondary battery of Example 26 was produced in the same manner as in Example 24 except that the electrolytic solution of Example 26 was used.

### Example 27

A lithium ion secondary battery of Example 27 was produced in the same manner as in Example 24 except that the electrolytic solution of Example 10 was used.

### Evaluation Example 12: Storage Test

For the lithium ion secondary batteries of Examples 24 to 27, the storage test was performed in the same manner as in Evaluation example 10.

Also in Evaluation example 12, the capacity was confirmed before and after the storage test as in Evaluation example 9, and a percentage of the discharge capacity after the storage test to the discharge capacity before the storage test was defined as a capacity retention rate of each lithium ion secondary battery. The result of the storage test is indicated in Table 17. The test was performed at n=2, and the average value in the tests is indicated in Table 17.

TABLE 17

| | | | Capacity |
|---|---|---|---|
| | Nonaqueous | | retention |
| | solvent | Additive | rate |
| Example 24 | EC and MP | LiBOB and VC | 96.5% |
| Example 25 | EC and MP | LiBOB and FEC | 96.5% |
| Example 26 | EC and MP | VC | 96.0% |
| Example 27 | EC and MP | LiDFOB and VC | 96.4% |
| Comparative | EC, EMC, and | LiDFOB and VC | 95.9% |
| example 10 | DMC | | |

As indicated in Table 17, also in a case where LiBOB as oxalate borate was used as the additive of the electrolytic solution, the capacity retention rate of the lithium ion secondary battery after storage at 40° C. was enhanced similarly to a case where LiDFOB as oxalate borate was used as the additive of the electrolytic solution. In a case where fluoroethylene carbonate was used in combination with LiBOB and in a case where vinylene carbonate was used in combination with LiBOB, the capacity retention rates indicated almost equal values. The capacity retention rate of the lithium ion secondary battery of Comparative example 10 was 95.9%. Therefore, by using LiBOB and LiDFOB as the additive of the electrolytic solution, the capacity retention rate of the lithium ion secondary battery after storage at 40° C. was considered to be enhanced to the same or higher degree as compared with Comparative example 10 in which a carbonate-based nonaqueous solvent was used as the nonaqueous solvent.

### Example 28

A lithium ion secondary battery of Example 28 was produced by using the electrolytic solution of Example 10 as follows.

LiFePO₄, as the positive electrode active material, having an olivine structure and coated with carbon, acetylene black as the conductive additive, and polyvinylidene fluoride as the binding agent were mixed such that a mass ratio among the positive electrode active material, the conductive additive, and the binding agent was 90:5:5, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed, to produce a positive electrode precursor. The produced positive electrode precursor was pressed in the thickness direction to produce a positive electrode having the positive electrode active material layer formed on the surface of the aluminum foil.

In the production of the positive electrode, the target weight per area of the positive electrode was 40 mg/cm², and the target density of the positive electrode active material layer was 2 g/cm³.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil into a film-like form, and the solvent was thereafter removed, to produce a negative electrode precursor. The produced negative electrode precursor was pressed in the thickness direction to produce a negative electrode having the negative electrode active material layer formed on the surface of the copper foil.

In the production of the negative electrode, the target weight per area of the negative electrode was 18 mg/cm², and the target density of the negative electrode active material layer was 1.3 g/cm³.

A porous polypropylene film was prepared as a separator. The separator was held between the positive electrode and the negative electrode to produce an electrode assembly. The electrode assembly was put and sealed together with the electrolytic solution of Example 10 in a laminate film in a bag-like form, to produce a lithium ion secondary battery of Example 28.

### Comparative Example 11

A lithium ion secondary battery of Comparative example 11 was produced in the same manner as in Example 28 except that the electrolytic solution of Comparative example 9 was used.

### Evaluation Example 13: Rate Characteristics Evaluation Test

The lithium ion secondary batteries of Example 28 and Comparative example 11 were discharged at four discharge rates of 1 C, 2 C, 3 C, and 4 C to the voltage of 2.29 V from the SOC of 95%. Comparison in capacity, that is, rate capacity at a time when discharging of each lithium ion secondary battery ended was performed for each discharge rate, to evaluate rate characteristics of the lithium ion secondary batteries of Example 28 and Comparative example 11. The rate characteristics evaluation test was performed at n=3 at each of the C rates, and the average value in the tests was used for the comparison.

For each lithium ion secondary battery, a charge capacity obtained by CC-CV charging to 4.0 V at a rate of 0.4 C was defined as the SOC of 100%. The rate capacity was represented by a percentage relative to the SOC of 100%.

A rate capacity of the lithium ion secondary battery of Example 28 relative to a rate capacity of the lithium ion secondary battery of Comparative example 11 was represented by a percentage for each discharge rate, and the difference therebetween was defined as an increase rate (%) of the rate capacity.

The result is indicated in Table 18.

TABLE 18

| | Nonaqueous | | Rate capacity (%) | | | |
|---|---|---|---|---|---|---|
| | solvent | Additive | 1 C | 2 C | 3 C | 4 C |
| Example 28 | EC and MP | LiDFOB | 101 | 91 | 71 | 55 |
| | | and VC | | | | |
| Comparative | EC, FEC, | Absent | 97 | 67 | 47 | 37 |
| example 11 | EMC, and | | | | | |
| | DMC | | | | | |

| | | | | |
|---|---|---|---|---|
| Increase rate (%) of rate | 4 | 35 | 52 | 50 |
| capacity | | | | |

As indicated in Table 18, the lithium ion secondary battery of Example 28 in which methyl propionate was used as the nonaqueous solvent of the electrolytic solution had more excellent discharge rate characteristics as compared with the lithium ion secondary battery of Comparative example 11 in which only a carbonate-based nonaqueous solvent was used as the nonaqueous solvent of the electrolytic solution. Particularly, at a high discharge rate such as 3 C rate and 4 C rate, the rate capacity of the lithium ion secondary battery of Example 28 reached 1.5 times the rate capacity of the lithium ion secondary battery of Comparative example 11.

The result indicates that the discharge rate characteristics of the lithium ion secondary battery were significantly enhanced by using methyl propionate instead of carbonate as the nonaqueous solvent of the electrolytic solution.

### Example 29

A lithium ion secondary battery of Example 29 was produced in the same manner as in Example 24 except that the electrolytic solution of Example 10 was used.

### Comparative Example 12

LiPF₆ was dissolved at a concentration of 1.2 mol/L in a mixed solvent in which ethylene carbonate and propyl propionate (hereinafter, may be abbreviated as PP) were mixed at a volume ratio of 15:85 to obtain a mother liquor. LiDFOB in an amount equivalent to 1 mass % with respect to the mother liquor and vinylene carbonate in an amount equivalent to 1 mass % with respect to the mother liquor were added and dissolved to produce an electrolytic solution of Comparative example 12.

A lithium ion secondary battery of Comparative example 12 was produced in the same manner as in Example 24 except that the electrolytic solution of Comparative example 12 was used.

### Comparative Example 13

LiPF₆ was dissolved at a concentration of 1.2 mol/L in a mixed solvent in which ethylene carbonate and methyl butyrate (hereinafter, may be abbreviated as MB) were mixed at a volume ratio of 15:85 to produce a mother liquor. LiDFOB in an amount equivalent to 1 mass % with respect to the mother liquor and vinylene carbonate in an amount equivalent to 1 mass % with respect to the mother liquor were added and dissolved to produce an electrolytic solution of Comparative example 13.

A lithium ion secondary battery of Comparative example 13 was produced in the same manner as in Example 24 except that the electrolytic solution of Comparative example 13 was used.

### Comparative Example 14

LiPF₆ was dissolved at a concentration of 1.2 mol/L in a mixed solvent in which ethylene carbonate and ethyl butyrate (hereinafter, may be abbreviated as EB) were mixed at a volume ratio of 15:85 to produce a mother liquor. LiDFOB in an amount equivalent to 1 mass % with respect to the mother liquor and vinylene carbonate in an amount equivalent to 1 mass % with respect to the mother liquor were added and dissolved to produce an electrolytic solution of Comparative example 14.

A lithium ion secondary battery of Comparative example 14 was produced in the same manner as in Example 24 except that the electrolytic solution of Comparative example 14 was used.

### Comparative Example 15

Ethylene carbonate, ethyl methyl carbonate, and dimethyl carbonate were mixed at a volume ratio of 30:30:40 to produce a mixed solvent. LiPF₆ was dissolved in the mixed solvent to produce a mother liquor in which the LiPF₆ concentration was 1 mol/L. LiDFOB in an amount equivalent to 0.2 mol/L with respect to the mother liquor and vinylene carbonate in an amount equivalent to 1 mass % with respect to the mother liquor were added and dissolved to produce an electrolytic solution of Comparative example 15.

A lithium ion secondary battery of Comparative example 15 was produced in the same manner as in Example 24 except that the electrolytic solution of Comparative example 15 was used.

### Evaluation Example 14: Storage Test

For the lithium ion secondary batteries of Example 29 and Comparative examples 12 to 15, CC-CV charging to 4.0 V was performed at a rate of 0.4 C, and a charge capacity at this time was defined as a reference (SOC of 100%). A storage test in which each of the lithium ion secondary batteries at the SOC of 100 was stored at 40° C. for 11 days, was performed.

Before and after the storage test, similarly to Evaluation example 9, the capacity was confirmed, and a percentage of the discharge capacity after the storage test to the discharge capacity before the storage test was defined as a capacity retention rate of each lithium ion secondary battery.

After the storage test, a voltage change amount was measured when each lithium ion secondary battery in which the SOC was adjusted to 60% was discharged at a constant current rate for five seconds under a condition of 25° C. The measurement was performed under a plurality of conditions generated by changing the current rate. A constant current (mA) at which a time for discharging to a voltage of 2.5 V was 10 seconds was calculated for each lithium ion secondary battery having the SOC of 60% according to the obtained result. A value obtained by multiplying the voltage change amount in change from the SOC of 60% to 2.5 V, by the calculated constant current, was defined as an output.

The result of the above-described storage test is indicated in Table 19.

TABLE 19

| | | | Capacity | |
|---|---|---|---|---|
| | Nonaqueous | | retention | |
| | solvent | Additive | rate | Output |
| Example 29 | EC and MP | LiDFOB and VC | 95.6% | 1649 mW |
| Comparative | EC and PP | LiDFOB and VC | 96.2% | 1137 mW |
| example 12 | | | | |
| Comparative | EC and MB | LiDFOB and VC | 95.8% | 1328 mW |
| example 13 | | | | |
| Comparative | EC and EB | LiDFOB and VC | 95.8% | 1052 mW |
| example 14 | | | | |
| Comparative | EC, EMC, and | LiDFOB and VC | 95.6% | 1405 mW |
| example 15 | DMC | | | |

As indicated in Table 19, the lithium ion secondary battery of Example 29 in which methyl propionate was used as the nonaqueous solvent of the electrolytic solution was excellent in both the capacity retention rate and the output, and, particularly, exhibited an output that was much larger than that of Comparative example 15 in which the carbonate-based nonaqueous solvent was used as the nonaqueous solvent. According to the result, usefulness of selecting methyl propionate as the nonaqueous solvent was supported.

### Example 30

A lithium ion secondary battery of Example 30 was produced in the same manner as in Example 10 except that the target weight per area of the negative electrode was 6.2 mg/cm², and the target density of the negative electrode active material layer was 1.5 g/cm³ in the production of the negative electrode. The electrolytic solution of the lithium ion secondary battery of Example 30 was the same as the electrolytic solution of Example 10. That is, the electrolytic solution was obtained by dissolving LiPF₆ at a concentration of 1.2 mol/L in a mixed solvent in which ethylene carbonate and methyl propionate were mixed at a volume ratio of 15:85 to produce a mother liquor, and adding and dissolving LiDFOB in an amount equivalent to 1 mass % with respect to the mother liquor and vinylene carbonate in an amount equivalent to 1 mass % with respect to the mother liquor.

### Example 31

An electrolytic solution of Example 31 was produced in the same manner as in Example 10 except that LiPF₆ was dissolved at a concentration of 1.2 mol/L in a mixed solvent in which ethylene carbonate, propylene carbonate, and methyl propionate were mixed at a volume ratio of 10:5:85 to produce a mother liquor. A lithium ion secondary battery of Example 31 was produced in the same manner as in Example 30 except that the electrolytic solution of Example 31 was used.

### Example 32

An electrolytic solution of Example 32 was produced in the same manner as in Example 10 except that LiPF₆ was dissolved at a concentration of 1.2 mol/L in a mixed solvent in which ethylene carbonate, propylene carbonate, and methyl propionate were mixed at a volume ratio of 5:10:85 to produce a mother liquor. A lithium ion secondary battery of Example 32 was produced in the same manner as in Example 30 except that the electrolytic solution of Example 32 was used.

### Example 33

An electrolytic solution of Example 33 was produced in the same manner as in Example 10 except that LiPF₆ was dissolved at a concentration of 1.2 mol/L in a mixed solvent in which propylene carbonate and methyl propionate were mixed at a volume ratio of 15:85 to produce a mother liquor. A lithium ion secondary battery of Example 33 was produced in the same manner as in Example 30 except that the electrolytic solution of Example 33 was used.

### Evaluation Example 15: High Temperature Charging/Discharging Cycle Test

For the lithium ion secondary batteries of Examples 30 to 33, a high temperature charging/discharging cycle test was performed.

[Confirmation of Capacity]

Firstly, prior to the high temperature charging/discharging cycle test, CC-CV charging to 4.0 V was performed at a rate of 0.4 C. Subsequently, CC-CV discharging to 2.5 V was performed at a rate of 1 C over two hours. Thus, the discharge capacity of each lithium ion secondary battery was confirmed.

[High Temperature Charging/Discharging Cycle]

Thereafter, a high temperature charging/discharging cycle in which CC-CV charging to 4.0 V was performed at 60° C. at a rate of 1 C, and CC discharging was performed at a rate of 1 C until the SOD became 90%, was repeated 300 times. In the description herein, the charging means that lithium ions are moved from the positive electrode to the negative electrode and a potential difference between the positive electrode and the negative electrode is increased.

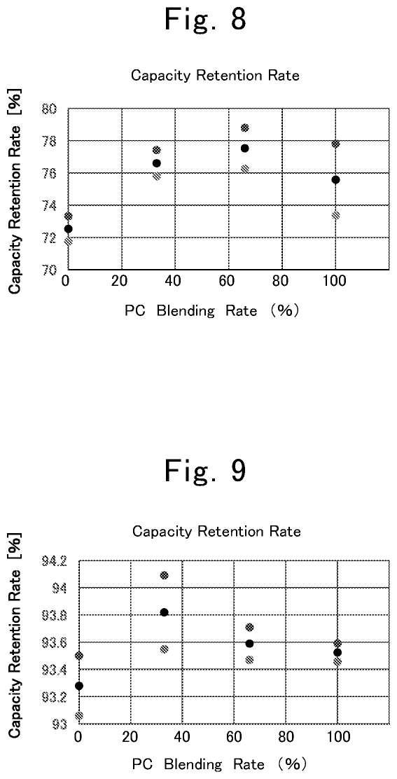

After end of the 300-th charging/discharging, a capacity of each lithium ion secondary battery was confirmed similarly to the above-described confirmation of the capacity. A percentage of the discharge capacity after the high temperature charging/discharging cycle to the discharge capacity before the high temperature charging/discharging cycle was defined as a capacity retention rate of each lithium ion secondary battery. An initial capacity of each lithium ion secondary battery is indicated in Table 20, and the result of the high temperature charging/discharging cycle test is indicated in Table 21 and FIG. 8. The test was performed at n=3, and the average value in the tests is indicated in Tables 20 and 21. The PC blending rate in FIG. 8 represents a percentage of a volume of propylene carbonate relative to the sum of a volume of ethylene carbonate and the volume of the propylene carbonate in the mother liquor.

TABLE 20

| | | | Initial |
|---|---|---|---|
| | | | capacity |
| | Mother liquor | Additive | (mAh) |
| Example 30 | 1.2M LiPF₆ | 1 wt % VC | 13.5 |
| | EC:PC:MP = 15:0:85 | 1 wt % LiDFOB | |
| Example 31 | 1.2M LiPF₆ | 1 wt % VC | 13.5 |
| | EC:PC:MP = 10:5:85 | 1 wt % LiDFOB | |
| Example 32 | 1.2M LiPF₆ | 1 wt % VC | 13.6 |
| | EC:PC:MP = 5:10:85 | 1 wt % LiDFOB | |
| Example 33 | 1.2M LiPF₆ | 1 wt % VC | 13.5 |
| | EC:PC:MP = 0:15:85 | 1 wt % LiDFOB | |

EC: ethylene carbonate,
PC: propylene carbonate,
MP: methyl propionate,
LiDFOB: lithium difluoro(oxalato)borate

TABLE 21

| | | | Capacity |
|---|---|---|---|
| | | | retention |
| | Mother liquor | Additive | rate (%) |
| Example 30 | 1.2M LiPF₆ | 1 wt % VC | 72.5 |
| | EC:PC:MP = 15:0:85 | 1 wt % LiDFOB | |
| | EC:PC = 100:0 | | |
| Example 31 | 1.2M LiPF₆ | 1 wt % VC | 76.6 |
| | EC:PC:MP = 10:5:85 | 1 wt % LiDFOB | |
| | EC:PC = 67:33 | | |
| Example 32 | 1.2M LiPF₆ | 1 wt % VC | 77.5 |
| | EC:PC:MP = 5:10:85 | 1 wt % LiDFOB | |
| | EC:PC = 33:67 | | |
| Example 33 | 1.2M LiPF₆ | 1 wt % VC | 75.6 |
| | EC:PC:MP = 0:15:85 | 1 wt % LiDFOB | |
| | EC:PC = 0:100 | | |

EC: ethylene carbonate,
PC: propylene carbonate,
MP: methyl propionate,
LiDFOB: lithium difluoro(oxalato)borate

In each of the lithium ion secondary batteries of Examples 30 to 33, graphite was used as the negative electrode. However, as indicated in Table 20, in a case where only ethylene carbonate was used as the nonaqueous solvent and in a case where propylene carbonate was used instead of ethylene carbonate as the nonaqueous solvent, initial capacities of the lithium ion secondary batteries were not substantially different, and an adverse affect on battery characteristics due to propylene carbonate was not found. This was assumed to be due to cooperation of other components in the electrolytic solutions of Examples 10 and 31 to 33 which were used for the lithium ion secondary batteries of Examples 30 to 33.

As indicated in Table 21, in a case where propylene carbonate was used as the nonaqueous solvent, the capacity retention rate of the lithium ion secondary battery was enhanced. The effect of enhancing the capacity retention rate became higher when both the ethylene carbonate and the propylene carbonate were used in combination, and was particularly significant in a case where a volume ratio between the ethylene carbonate and the propylene carbonate was in a range of 33:67 to 67:33 or a range of 50:50 to 25:75 as indicated in Table 21 and FIG. 8.

### Evaluation Example 16: Storage Test

For the lithium ion secondary batteries of Examples 30 to 33, CC-CV charging to 4.0 V was performed at a rate of 0.4 C, and a charge capacity at this time was defined as a reference (SOC of 100%). A storage test in which each of the lithium ion secondary batteries at the SOC of 100 was stored at 40° C. for 40 days, was performed.

Before and after the storage test, similarly to Evaluation example 15, the capacity was confirmed, and a percentage of the discharge capacity after the storage test to the discharge capacity before the storage test was defined as a capacity retention rate of each lithium ion secondary battery. The result of the storage test is indicated in Table 22 and FIG. 9. The test was performed at n=2, and the average value in the tests is indicated in Table 22. The PC blending rate in FIG. 9 represents a percentage of a volume of propylene carbonate relative to the sum of a volume of ethylene carbonate and the volume of the propylene carbonate in the mother liquor.

TABLE 22

| | | | Capacity |
|---|---|---|---|
| | | | retention |
| | Mother liquor | Additive | rate (%) |
| Example 30 | 1.2M LiPF₆ | 1 wt % VC | 93.3 |
| | EC:PC:MP = 15:0:85 | 1 wt % LiDFOB | |
| | EC:PC = 100:0 | | |
| Example 31 | 1.2M LiPF₆ | 1 wt % VC | 93.8 |
| | EC:PC:MP = 10:5:85 | 1 wt % LiDFOB | |
| | EC:PC = 67:33 | | |
| Example 32 | 1.2M LiPF₆ | 1 wt % VC | 93.6 |
| | EC:PC:MP = 5:10:85 | 1 wt % LiDFOB | |
| | EC:PC = 33:67 | | |
| Example 33 | 1.2M LiPF₆ | 1 wt % VC | 93.5 |
| | EC:PC:MP = 0:15:85 | 1 wt % LiDFOB | |
| | EC:PC = 0:100 | | |

EC: ethylene carbonate,
PC: propylene carbonate,
MP: methyl propionate,
LiDFOB: lithium difluoro(oxalato)borate

As indicated in Table 22, also in the storage test, similarly to the high temperature charging/discharging cycle test, by using propylene carbonate for the nonaqueous solvent, the capacity retention rate of the lithium ion secondary battery after storage at 40° C. was enhanced. The effect of enhancing the capacity retention rate became higher when both the ethylene carbonate and the propylene carbonate were used in combination, and was particularly significant in a case where a volume ratio between the ethylene carbonate and the propylene carbonate was in a range of 33:67 to 67:33 or a range of 75:25 to 25:75.

### Example 34

LiPF₆ was dissolved at a concentration of 1.2 mol/L in a mixed solvent in which ethylene carbonate and methyl propionate were mixed at a volume ratio of 15:85 to produce a mother liquor. LiDFOB in an amount equivalent to 1 mass % with respect to the mother liquor and vinylene carbonate in an amount equivalent to 1 mass % with respect to the mother liquor were added and dissolved to produce an electrolytic solution of Example 34. The composition of the electrolytic solution of Example 34 was the same as the composition of the electrolytic solution of Example 10.

LiMn_{0.75}Fe_{0.25}PO₄, as the positive electrode active material, having an olivine structure and coated with carbon, a carbon-based conductive additive as the conductive additive, and polyvinylidene fluoride as the binding agent were mixed such that a mass ratio among the positive electrode active material, the conductive additive, and the binding agent was 94.6:0.4:5.0, and N-methyl-2-pyrrolidone was added as a solvent to produce a positive electrode active material layer forming composition in a slurry form. Aluminum foil was prepared as a current collector for the positive electrode. The positive electrode active material layer forming composition was applied to the surface of the aluminum foil into a film-like form, and the solvent was thereafter removed, to produce a positive electrode precursor. The produced positive electrode precursor was pressed in the thickness direction to produce a positive electrode having the positive electrode active material layer formed on the surface of the aluminum foil.

In the production of the positive electrode, the target weight per area of the positive electrode was 13.9 mg/cm², and the target density of the positive electrode active material layer was 1.8 g/cm³.

Graphite as the negative electrode active material, and carboxymethylcellulose and styrene butadiene rubber as the binding agent were mixed such that a mass ratio among the graphite, the carboxymethylcellulose, and the styrene butadiene rubber was 97:0.8:2.2, and water was added as a solvent, to produce a negative electrode active material layer forming composition in a slurry form. Copper foil was prepared as a current collector for the negative electrode. The negative electrode active material layer forming composition was applied to the surface of the copper foil in a film-like form, and the solvent was thereafter removed, to produce a negative electrode precursor. The produced negative electrode precursor was pressed in the thickness direction to produce a negative electrode having the negative electrode active material layer formed on the surface of the copper foil.

In the production of the negative electrode, the target weight per area of the negative electrode was 6.3 mg/cm², and the target density of the negative electrode active material layer was 1.3 to 1.35 g/cm³.

A porous polypropylene film was prepared as a separator. The separator was held between the positive electrode and the negative electrode to produce an electrode assembly. The electrode assembly was put and sealed together with the electrolytic solution of Example 34 in a laminate film in a bag-like form to produce a lithium ion secondary battery of Example 34.

### Reference Example 1

An electrolytic solution of Reference example 1 was produced in the same manner as in Example 34 except that LiPF₆ was dissolved at a concentration of 1.2 mol/L in a mixed solvent in which ethylene carbonate and ethyl propionate were mixed at a volume ratio of 15:85 to produce a mother liquor. A lithium ion secondary battery of Reference example 1 was produced in the same manner as in Example 34 except that the electrolytic solution of Reference example 1 was used.

### Reference Example 2

An electrolytic solution of Reference example 2 was produced in the same manner as in Example 34 except that LiPF₆ was dissolved at a concentration of 1.2 mol/L in a mixed solvent in which ethylene carbonate and propyl propionate were mixed at a volume ratio of 15:85 to produce a mother liquor. A lithium ion secondary battery of Reference example 2 was produced in the same manner as in Example 34 except that the electrolytic solution of Reference example 2 was used.

### Example 35

An electrolytic solution of Example 35 was produced in the same manner as in Example 34 except that LiPF₆ was dissolved at a concentration of 1.2 mol/L in a mixed solvent in which ethylene carbonate, propylene carbonate, and methyl propionate were mixed at a volume ratio of 15:15:70 to produce a mother liquor. A lithium ion secondary battery of Example 35 was produced in the same manner as in Example 34 except that the electrolytic solution of Example 35 was used.

### Example 36

An electrolytic solution of Example 36 was produced in the same manner as in Example 34 except that LiPF₆ was dissolved at a concentration of 1.2 mol/L in a mixed solvent in which ethylene carbonate, propylene carbonate, and methyl propionate were mixed at a volume ratio of 15:30:55 to produce a mother liquor. A lithium ion secondary battery of Example 36 was produced in the same manner as in Example 34 except that the electrolytic solution of Example 36 was used.

### Comparative Example 16

LiPF₆ was dissolved at a concentration of 1.2 mol/L in a mixed solvent in which ethylene carbonate and methyl propionate were mixed at a volume ratio of 15:85 to produce an electrolytic solution of Comparative example 16. A lithium ion secondary battery of Comparative example 16 was produced in the same manner as in Example 34 except that the electrolytic solution of Comparative example 16 was used.

### Example 37

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor was added and dissolved to produce an electrolytic solution of Example 37. A lithium ion secondary battery of Example 37 was produced in the same manner as in Example 34 except that the electrolytic solution of Example 37 was used.

### Example 38

LiPF₆ was dissolved at a concentration of 1.2 mol/L in a mixed solvent in which ethylene carbonate and methyl propionate were mixed at a volume ratio of 15:85 to produce a mother liquor. Fluoroethylene carbonate in an amount equivalent to 1 mass % with respect to the mother liquor was added and dissolved to produce an electrolytic solution of Example 38. A lithium ion secondary battery of Example 38 was produced in the same manner as in Example 34 except that the electrolytic solution of Example 38 was used.

### Example 39

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor and 1,3-propanesultone in an amount equivalent to 0.5 mass % with respect to the mother liquor were added and dissolved to produce an electrolytic solution of Example 39. A lithium ion secondary battery of Example 39 was produced in the same manner as in Example 34 except that the electrolytic solution of Example 39 was used.

### Example 40

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor and succinonitrile in an amount equivalent to 0.5 mass % with respect to the mother liquor were added and dissolved to produce an electrolytic solution of Example 40. A lithium ion secondary battery of Example 40 was produced in the same manner as in Example 34 except that the electrolytic solution of Example 40 was used.

### Example 41

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor and lithium difluorophosphate in an amount equivalent to 1 mass % with respect to the mother liquor were added and dissolved to produce an electrolytic solution of Example 41. A lithium ion secondary battery of Example 41 was produced in the same manner as in Example 34 except that the electrolytic solution of Example 41 was used.

### Example 42

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor and LiDFOB in an amount equivalent to 0.5 mass % with respect to the mother liquor were added and dissolved to produce an electrolytic solution of Example 42. A lithium ion secondary battery of Example 42 was produced in the same manner as in Example 34 except that the electrolytic solution of Example 42 was used.

### Example 43

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor and LiDFOB in amount equivalent to 1.5 mass % with respect to the mother liquor were added and dissolved to produce an electrolytic solution of Example 43. A lithium ion secondary battery of Example 43 was produced in the same manner as in Example 34 except that the electrolytic solution of Example 43 was used.

### Example 44

LiPF₆ was dissolved at a concentration of 1.2 mol/L in a mixed solvent in which ethylene carbonate and methyl propionate were mixed at a volume ratio of 15:85 to produce a mother liquor. Vinylene carbonate in an amount equivalent to 1 mass % with respect to the mother liquor, LiDFOB in an amount equivalent to 1 mass % with respect the mother liquor, and succinonitrile in an amount equivalent to 0.5 mass % with respect to the mother liquor were added and dissolved to produce an electrolytic solution of Example 44. A lithium ion secondary battery of Example 44 was produced in the same manner as in Example 34 except that the electrolytic solution of Example 44 was used.

### Example 45

LiPF₆ was dissolved at a concentration of 1.2 mol/L in a mixed solvent in which ethylene carbonate, propylene carbonate, and methyl propionate were mixed at a volume ratio of 15:15:70 to produce a mother liquor. Vinylene carbonate in an amount equivalent to 1 mass % with respect to the mother liquor, LiDFOB in an amount equivalent to 1 mass % with respect to the mother liquor, and succinonitrile in an amount equivalent to 0.5 mass % with respect to the mother liquor were added and dissolved to produce an electrolytic solution of Example 45. A lithium ion secondary battery of Example 45 was produced in the same manner as in Example 34 except that the electrolytic solution of Example 45 was used.

### Example 46

LiPF₆ was dissolved at a concentration of 1.2 mol/L in a mixed solvent in which ethylene carbonate, propylene carbonate, and methyl propionate were mixed at a volume ratio of 15:15:70 to produce a mother liquor. Vinylene carbonate in an amount equivalent to 1 mass % with respect to the mother liquor, LiDFOB in an amount equivalent to 1 mass % with respect to the mother liquor, succinonitrile in an amount equivalent to 0.5 mass % with respect to the mother liquor, and fluoroethylene carbonate in an amount equivalent to 1 mass % with respect to the mother liquor were added and dissolved to produce an electrolytic solution of Example 46. A lithium ion secondary battery of Example 46 was produced in the same manner as in Example 34 except that the electrolytic solution of Example 46 was used.

### Example 47

LiPF₆ was dissolved at a concentration of 1.2 mol/L in a mixed solvent in which ethylene carbonate, propylene carbonate, and methyl propionate were mixed at a volume ratio of 15:15:70 to produce a mother liquor. Vinylene carbonate in an amount equivalent to 1 mass % with respect to the mother liquor, LiDFOB in an amount equivalent to 0.5 mass % with respect to the mother liquor, and succinonitrile in an amount equivalent to 0.5 mass % with respect to the mother liquor were added and dissolved to produce an electrolytic solution of Example 47. A lithium ion secondary battery of Example 47 was produced in the same manner as in Example 34 except that the electrolytic solution of Example 47 was used.

### Evaluation Example 16: High Temperature Charging/Discharging Cycle Test

For the lithium ion secondary batteries of Examples 34 to 47, Reference examples 1 and 2, and Comparative example 16, a high temperature charging/discharging cycle test was performed.

[Confirmation of Capacity]

Firstly, prior to the high temperature charging/discharging cycle test, CC-CV charging to 4.3 V was performed at a rate of 0.4 C. Thereafter, CC-CV discharging to 3 V was performed at a rate of 0.33 C. Thus, a discharge capacity of each lithium ion secondary battery was confirmed.

[High Temperature Charging/Discharging Cycle]

Thereafter, a high temperature charging/discharging cycle in which CC-CV charging to 4.3 V was performed at 60° C. at a rate of 1 C, and CC discharging was performed at a rate of 1 C until the SOD became 90%, was repeated 100 times. In the description herein, the charging means that lithium ions are moved from the negative electrode to the positive electrode and a potential difference between the positive electrode and the negative electrode is increased.

After end of the 100-th charging/discharging, a capacity of each lithium ion secondary battery was confirmed similarly to the above-described confirmation of the capacity. A percentage of the discharge capacity after the high temperature charging/discharging cycle to the discharge capacity before the high temperature charging/discharging cycle was defined as a capacity retention rate of each lithium ion secondary battery. The initial capacity of each lithium ion secondary battery is indicated in Tables 23 to 27. The test was performed at n=2, and the average value in the tests is indicated in Tables 20 and 21.

TABLE 23

| | | | Capacity |
|---|---|---|---|
| | | | retention |
| | Mother liquor | Additive | rate (%) |
| Example 34 | 1.2M LiPF₆ | 1 wt % VC | 81.1 |
| | EC:MP = 15:85 | 1 wt % LiDFOB | |
| Reference | 1.2M LiPF₆ | 1 wt % VC | 76.6 |
| example 1 | EC:EP = 15:85 | 1 wt % LiDFOB | |
| Reference | 1.2M LiPF₆ | 1 wt % VC | 74.7 |
| example 2 | EC:PP = 15:85 | 1 wt % LiDFOB | |

EC: ethylene carbonate,
MP: methyl propionate,
EP: ethyl propionate,
PP: propyl propionate,
VC: vinylene carbonate,
LiDFOB: lithium difluoro(oxalato)borate

As indicated in Table 23, the lithium ion secondary battery of Example 34 in which methyl propionate was used as a main solvent of the electrolytic solution had a greater capacity retention rate and more excellent durability as compared with the lithium ion secondary battery of Reference example 1 in which ethyl propionate was used as a main solvent of the electrolytic solution, and the lithium ion secondary battery of Reference example 2 in which propyl propionate was used as a main solvent of the electrolytic solution. Thus, also for the lithium ion secondary battery in which LiMn_{0.75}Fe_{0.25}PO₄ as a kind of LiMnₓFe_{y}PO₄ was used for the positive electrode active material, the electrolytic solution of the present invention in which methyl propionate was used as the main solvent was considered to be suitable.

TABLE 24

| | | | Capacity |
|---|---|---|---|
| | | | retention |
| | Mother liquor | Additive | rate (%) |
| Example 34 | 1.2M LiPF₆ | 1 wt % VC | 81.1 |
| | EC:MP = 15:85 | 1 wt % LiDFOB | |
| Example 35 | 1.2M LiPF₆ | 1 wt % VC | 81.9 |
| | EC:PC:MP = 15:15:70 | 1 wt % LiDFOB | |
| Example 36 | 1.2M LiPF₆ | 1 wt % VC | 81.3 |
| | EC:PC:MP = 15:30:55 | 1 wt % LiDFOB | |

EC: ethylene carbonate,
MP: methyl propionate,
PC: propylene carbonate,
VC: vinylene carbonate,
LiDFOB: lithium difluoro(oxalato)borate

As indicated in Table 24, in a case where both ethylene carbonate and propylene carbonate were used in combination as a sub-solvent of the electrolytic solution as in Examples 35 and 36, the lithium ion secondary battery had an enhanced capacity retention rate and excellent durability, as compared with a case where only ethylene carbonate was used as a sub-solvent as in Example 34. According to this result, containing propylene carbonate in the nonaqueous solvent was considered to be useful also in a case where LiMnₓFe_{y}PO₄ was used for the positive electrode active material.

For durability, Example 35>Example 36>Example 34 was satisfied. Therefore, in a case where LiMnₓFe_{y}PO₄ was used as the positive electrode active material, a ratio between ethylene carbonate and propylene carbonate was preferably in a range of 30:70 to 70:30 and particularly preferably in a range of 60:40 to 40:60.

TABLE 25

| | | | Capacity |
|---|---|---|---|
| | | | retention |
| | Mother liquor | Additive | rate (%) |
| Comparative | 1.2M LiPF₆ | Absent | 72.7 |
| example 16 | EC:MP = 15:85 | | |
| Example 37 | 1.2M LiPF₆ | 1 wt % VC | 75.9 |
| | EC:MP = 15:85 | | |
| Example 38 | 1.2M LiPF₆ | 1 wt % FEC | 75.8 |
| | EC:MP = 15:85 | | |
| Example 39 | 1.2M LiPF₆ | 1 wt % VC | 76.8 |
| | EC:MP = 15:85 | 1 wt % PS | |
| Example 40 | 1.2M LiPF₆ | 1 wt % VC | 80.0 |
| | EC:MP = 15:85 | 1 wt % SN | |
| Example 41 | 1.2M LiPF₆ | 1 wt % VC | 76.0 |
| | EC:MP = 15:85 | 1 wt % LiPO₂F₂ | |
| Example 34 | 1.2M LiPF₆ | 1 wt % VC | 81.1 |
| | EC:MP = 15:85 | 1 wt % LiDFOB | |

EC: ethylene carbonate,
MP: methyl propionate,
VC: vinylene carbonate,
FEC: fluoroethylene carbonate,
PS: 1,3-propanesultone,
SN: succinonitrile,
LiPO₂F₂: lithium difluorophosphate,
LiDFOB: lithium difluoro(oxalato)borate

As indicated in Table 25, the lithium ion secondary battery of each of Examples 34 and 37 to 41 had a greater capacity retention rate and excellent durability as compared with the lithium ion secondary battery of Comparative example 16. This result indicates that the electrolytic solution of the present invention containing the additive in the electrolytic solution was considered to be useful also in a case where LiMnₓFe_{y}PO₄ was used for the positive electrode active material. Since durability was particularly excellent in Example 34, Example 39, and Example 40, both vinylene carbonate and LiDFOB were considered to be particularly preferably used in combination as the additive or a nitrile in addition to vinylene carbonate as the additive was considered to be particularly preferably used as a second additive.

TABLE 26

| | | | Capacity |
|---|---|---|---|
| | | | retention |
| | Mother liquor | Additive | rate (%) |
| Example 42 | 1.2M LiPF₆ | 1 wt % VC | 72.7 |
| | EC:MP = 15:85 | 0.5 wt % LiDFOB | |
| Example 34 | 1.2M LiPF₆ | 1 wt % VC | 81.1 |
| | EC:MP = 15:85 | 1 wt % LiDFOB | |
| Example 43 | 1.2M LiPF₆ | 1 wt % VC | 76.3 |
| | EC:MP = 15:85 | 1.5 wt % LiDFOB | |

EC: ethylene carbonate,
MP: methyl propionate,
VC: vinylene carbonate,
LiDFOB: lithium difluoro(oxalato)borate

As indicated in Table 26, for the capacity retention rate of the lithium ion secondary battery, Example 34>Example 43>Example 42 was satisfied. This result indicates that the content of LiDFOB was considered to be particularly preferably in a range of 0.6 to 2 mass %, a range of 0.6 to 1.5 mass %, or a range of 0.6 to 1.4 mass % with respect to the total mass of the mother liquor, that is, the total mass excluding the mass of the additive of the present invention, in a case where LiMnₓFe_{y}PO₄ was used for the positive electrode active material.

TABLE 27

| | | | Capacity |
|---|---|---|---|
| | | | retention |
| | Mother liquor | Additive | rate (%) |
| Example 34 | 1.2M LiPF₆ | 1 wt % VC | 81.1 |
| | EC:MP = 15:85 | 1 wt % LiDFOB | |
| Example 44 | 1.2M LiPF₆ | 1 wt % VC | 82.7 |
| | EC:MP = 15:85 | 1 wt % LiDFOB | |
| | | 0.5 wt % SN | |
| Example 45 | 1.2M LiPF₆ | 1 wt % VC | 81.4 |
| | EC:PC:MP = 15:15:70 | 1 wt % LiDFOB | |
| | | 0.5 wt % SN | |
| Example 46 | 1.2M LiPF₆ | 1 wt % VC | 81.4 |
| | EC:PC:MP = 15:15:70 | 1 wt % LiDFOB | |
| | | 0.5 wt % SN | |
| | | 1 wt % FEC | |
| Example 47 | 1.2M LiPF₆ | 1 wt % VC | 81.8 |
| | EC:PC:MP = 15:15:70 | 0.5 wt % LiDFOB | |
| | | 0.5 wt % SN | |

EC: ethylene carbonate,
PC: propylene carbonate,
MP: methyl propionate,
VC: vinylene carbonate,
FEC: fluoroethylene carbonate,
SN: succinonitrile,
LiDFOB: lithium difluoro(oxalato)borate

As indicated in Table 27, the capacity retention rate of the lithium ion secondary battery in which LiMnₓFe_{y}PO₄ was used for the positive electrode active material and LiDFOB was used as the additive in the electrolytic solution was considered to be enhanced by adding a nitrile as the second additive to the electrolytic solution.

1. A lithium ion secondary battery comprising:
a positive electrode that includes a positive electrode active material having an olivine structure;
a negative electrode having graphite as a negative electrode active material; and
an electrolytic solution, wherein
the electrolytic solution contains LiPF₆, a cyclic alkylene carbonate selected from ethylene carbonate and propylene carbonate, methyl propionate, and an additive that starts reductive degradation at a potential higher than a potential at which the above components of the electrolytic solution start reductive degradation.

2. The lithium ion secondary battery according to claim 1, wherein the additive is cyclic sulfate ester and/or oxalate borate.

3. The lithium ion secondary battery according to claim 1, wherein the electrolytic solution contains a fluorine-containing cyclic carbonate and/or an unsaturated cyclic carbonate.

4. The lithium ion secondary battery according to claim 1, wherein the additive is lithium difluoro(oxalato)borate and/or lithium bis(oxalato)borate, and the electrolytic solution contains fluoroethylene carbonate and/or vinylene carbonate.

5. The lithium ion secondary battery according to claim 1, wherein a concentration of lithium ions in the electrolytic solution is in a range of 0.8 to 1.8 mol/L.

6. The lithium ion secondary battery according to claim 1, wherein a proportion of the methyl propionate in the electrolytic solution is 50 to 95 volume % with respect to a total volume of the cyclic alkylene carbonate and the methyl propionate.

7. The lithium ion secondary battery according to claim 1, wherein a proportion of the cyclic alkylene carbonate to an entire nonaqueous solvent in the electrolytic solution is 5 to 30 volume %.

8. The lithium ion secondary battery according to claim 1, wherein an amount of a positive electrode active material layer formed on one surface of current collector foil of the positive electrode is not less than 20 mg/cm², and an amount of a negative electrode active material layer formed on one surface of current collector foil of the negative electrode is not less than 10 mg/cm².

9. The lithium ion secondary battery according to claim 1, comprising a bipolar electrode in which a positive electrode active material layer is formed on one surface of current collector foil and a negative electrode active material layer is formed on another surface.

10. The lithium ion secondary battery according to claim 1, wherein the electrolytic solution contains the propylene carbonate.

11. The lithium ion secondary battery according to claim 10, wherein a proportion of the propylene carbonate to the cyclic alkylene carbonate in the electrolytic solution is 20 to 80 volume %.

12. The lithium ion secondary battery according to claim 1, wherein
the positive electrode contains LiMnₓFe_{y}PO₄ (x and y satisfy x+y=1, 0<x<1, and 0<y<1) as the positive electrode active material, and
the electrolytic solution contains a nitrile as a second additive.
